(19) United States
(12) Patent Application Publication
(10) Pub. No.: US 2020/0374146 A1
(43) Pub. Date: Nov. 26, 2020

(54) GENERATION OF INTELLIGENT SUMMARIES OF SHARED CONTENT BASED ON A CONTEXTUAL ANALYSIS OF USER ENGAGEMENT

(71) Applicant: MICROSOFT TECHNOLOGY LICENSING, LLC, Redmond, WA (US)

(72) Inventors: Shalendra CHHABRA, Seattle, WA (US); Eric R. SEXAUER, Seattle, WA (US); Jason Thomas FAULKNER, Seattle, WA (US)

(21) Appl. No.: 16/422,922

(22) Filed: May 24, 2019

(51) Int. Cl. H04L 12/18

(52) U.S. Cl. CPC H04L 12/1831; H04L 12/1822

(57) ABSTRACT

The techniques disclosed herein improve existing systems by automatically generating summaries of shared content based on a contextual analysis of a user's engagement with an event. User activity data from a number of sensors and other contextual data, such as scheduling data and communication data, can be analyzed to determine a user's level of engagement of an event. A system can automatically generate a summary of any shared content the user may have missed during a time period that the user was not engaged with the event. For example, if a user becomes distracted or is otherwise unavailable during a presentation, the system can provide a summary of salient portions of content that was shared during the time of the user's inattentive status, such as, but not limited to, key topics, tasks, shared files, an excerpt of a transcript of a presentation or any salient sections of a shared video.

### BACKGROUND

There are a number of different systems and applications that allow users to collaborate. For example, some systems allow people to collaborate by the use of live video streams, live audio streams, and other forms of real-time text-based or image-based mediums. Some systems also allow users to share files during a communication session. Further, some systems provide users with tools for editing content of shared files.

Although there are a number of different types of systems and applications that allow users to collaborate, users may not always benefit from existing systems. For example, if a person takes time off from work, that user may miss a number of meetings and other events where content is shared between a number of different people. Upon returning to work, it may take some time for that person to catch up with the activities of each missed event. When it comes to tracking messages within a communication channel having a large number of entries, the user may have a difficult time following the conversation. Even worse, if a person is out of the office for an extended period of time, e.g., a vacation, there may be hundreds or even thousands of messages within a particular channel along with a vast amount of shared files. Given the vast amount of information that can be shared, any person can have a difficult time catching up from a number of missed events.

In another example, when people are participating in an in-person meeting, there are a number of activities that can distract meeting participants. For instance, a meeting participant may take a phone call and disengage from an event such as a presentation. In another example, a meeting participant may engage in a side conversation with other participants of the meeting causing a distraction to themselves and others in the meeting. Such activities may cause participants of an event to miss key aspects of a presentation. Participants of the meeting may also become disengaged and miss shared content due to fatigue or other reasons. Regardless of the reason of a distraction, participants of an event may find it difficult to catch up on key aspects of any shared content they missed.

The drawbacks of existing systems, such as those described above, can lead to loss of productivity as well as inefficient use of computing resources. When a participant of a meeting or a collaboration session becomes disengaged, even for short period, that participant can be required to sift through a large amount of information to find salient information from all of the shared content. In addition to sifting through a large number of documents, channel posts, video recordings, or other related information, participants may be required to send requests to other participants to identify salient content they missed. Such methods can utilize a considerable amount of computing resources as well as cause a loss of productivity for individuals receiving such requests. Also, when a person is required to acquire and review large amounts of information, a number of computing resources, such as networking resources and processing resources, are not utilized in an optimal manner.

### SUMMARY

The techniques disclosed herein improve existing systems by automatically generating summaries of shared content a person may have missed due to a lack of engagement during an event. In some embodiments, contextual data, such as scheduling data, communication data and sensor data, can be analyzed to determine a user's level of engagement. A system can automatically generate a summary of any shared content the user may have missed during a time period that the user was not engaged. For example, if a user becomes distracted or is otherwise unavailable during a presentation, the system can provide a summary of salient portions of the presentation and other content that was shared during the time the user was distracted or unavailable. An automatically generated summary can include salient content such as key topics, tasks, and summaries of shared files. A summary can also include excerpts of a transcript of a presentation, reports on meetings, salient sections of channel conversations, key topics of unread emails, etc. Automatic delivery of such summaries can help computer users maintain engagement with a number of events with overlapping schedules. Long periods of unavailability can also be addressed by the techniques presented herein. For instance, if a person takes a vacation, a summary can be automatically generated when the person returns to the office.

Various combinations of contextual data can be analyzed to determine a person's level of engagement. In some implementations, video data generated by a camera can be analyzed to determine a person's level of engagement. The analysis of video data can enable a system to analyze a person's gaze gestures to determine if they are engaged within a particular target. For instance, if a person is participating in a meeting and that person looks at his or her phone for a predetermined time period, the system can determine that the person does not have a threshold level of engagement with respect to any content shared during the meeting. Similarly, if the user closes their eyes for a predetermined time period, the system can analyze such activity and determine that person does not have a threshold level of engagement.

In some implementations, communication data can be analyzed to determine a person's level of engagement. The communication data can include activity data from any communication system, such as a mobile network, email system, chat system, or a channel communication system. In one example, if a person is participating in a meeting and that person takes a phone call during the meeting, the system can analyze user activity data on a network and determine that the person does not have a threshold level of engagement with respect to the meeting. A similar analysis can be performed on other forms of communication data such as private chat data, email message data, channel data, etc. Thus, a system can analyze emails generated by a user and determine they are or are not engaged with an event, such as a meeting.

In some implementations, audio data can be analyzed to determine a person's level of engagement. For instance, a conference room may have a number of microphones for capturing various conversations within a room. If a particular user starts to engage in a side conversation during a presentation, the system can determine that the person does not have a threshold level of engagement with respect to the presentation. The system can also utilize the microphone to monitor the presentation and generate a summary describing the portion of the presentation the user missed while they were engaged in the side conversation.

In some implementations, different combinations of contextual data from multiple resources can be analyzed to determine a person's level of engagement. Contextual data can include any information describing a user's activity. For example, contextual data can include scheduling data, social media data, location data, a user's behavioral history, or gestures performed by a particular user. In one illustrative example, a user's location data, which can be provided by a location service or a location device, can be used to determine that a person was late to a particular meeting or left a meeting early. The location data can be used to determine when the person left the meeting and when the person returned to the meeting. Such information can be used to generate a summary during a time period the user was not in attendance. In another illustrative example, a person's calendar data can be analyzed alone or in conjunction with other contextual data, which may include data generated by a sensor or data provided by a resource. Such implementations can enable a system to analyze or confirm longer periods of disengagement, such as vacations, off-site meetings, etc.

As will be described in detail below, the combination of different types of contextual data can be analyzed to determine a person's level of engagement for the purposes of generating a summary of content that the person missed during an event or a series of events. For instance, if a person's location information or travel itinerary indicates that they are out of town, the system may gather content from all meetings that are scheduled during their absence. It can also be appreciated that any combination of contextual data received from multiple types of resources can be used to generate a summary. For instance, communication data, such as audio streams of a communication session or a broadcast, can be interpreted and transcribed to generate a description of salient portions of an event. In addition, a system may utilize one or more machine learning algorithms for refining the process of determining a threshold level of engagement for a user.

A system can also identify permissions for certain sections of the summary and take actions on those summaries based on the permissions. For instance, consider a scenario where a person is unable to review the contents of a communication channel during a given time period. Based on one or more techniques described herein, the system may generate a summary of the channel contents during that time period. If the channel contents include a file having encrypted sections, the system may redact the encrypted sections from the summary. In other embodiments, the system may modify one or more permissions allowing a recipient of the summary to review the encrypted sections.

The techniques described above can lead to more efficient use of computing resources. In particular, by automating a number of different processes for generating a summary, user interaction with the computing device can be improved. The techniques disclosed herein can lead to a more efficient use of computing resources by eliminating the need for a person to perform a number of manual steps to search, discover, review, display, and retrieve vast amounts of data they have missed during a user's inattentive status. The automatic generation of a summary of missed content can mitigate the need for a user to search, discover, review, display, and retrieve the vast amount of data. Also, by reducing the need for manual entry, inadvertent inputs and human error can be reduced. This can ultimately lead to more efficient use of computing resources such as memory usage, network usage, processing resources, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. References made to individual items of a plurality of items can use a reference number with a letter of a sequence of letters to refer to each individual item. Generic references to the items may use the specific reference number without the sequence of letters. The same reference numbers in different figures indicate similar or identical items.

FIG. 1 illustrates aspects of a system utilizing various resources and sensors to determine a level of engagement of a user for the purpose of generating a summary of content.

FIG. 2 illustrates a sample set of scheduling data and location data that can be used to determine a user level of engagement for an event for the purpose of generating a summary of content.

FIG. 3 illustrates a sample set of communication data and location data that can be used to determine a user level of engagement for an event for the purpose of generating a summary of content.

FIG. 4 illustrates a sample set of sensor data that can be used to determine a user level of engagement for an event for the purpose of generating a summary of content.

FIG. 5A illustrates a sample set of scheduling data that lists a number of events for a user.

FIG. 5B illustrates the sample set of scheduling data of FIG. 5A along with supplemental data indicating the availability of the user.

FIG. 5C illustrates how events of a schedule can be selected and used to generate a summary of content.

FIG. 5D illustrates a user interface displaying an example of a graphical element used to highlight events of a schedule based on a user selection of a section of a summary.

FIG. 5E illustrates a user interface displaying an example of a graphical element used to highlight events of a schedule based on a selection of a section of a summary.

FIG. 6 illustrates an example of a user interface that provides a first graphical element identifying text that is quoted from shared content and a second graphical element identifying computer-generated summaries of the shared content.

FIG. 7 illustrates a sequence of steps of a transition of a user interface when the user selects a section of a summary for identifying a source of summarized information.

FIG. 8A illustrates a user interface displaying a number of summaries generated from the selected portions of shared content.

FIG. 8B illustrates a user interface displaying an example of an updated graphical element representing a history of channel items having highlighted topics.

FIG. 9 illustrates an example dataflow diagram showing how a system for generating one or more summaries can collect information from various resources.

FIG. 10 is a flow diagram illustrating aspects of a routine for computationally efficient generation of a summary from content shared in association with an event .

FIG. 11 is a computing system diagram showing aspects of an illustrative operating environment for the technologies disclosed herein.

FIG. 12 is a computing architecture diagram showing aspects of the configuration and operation of a computing device that can implement aspects of the technologies disclosed herein.

### DETAILED DESCRIPTION

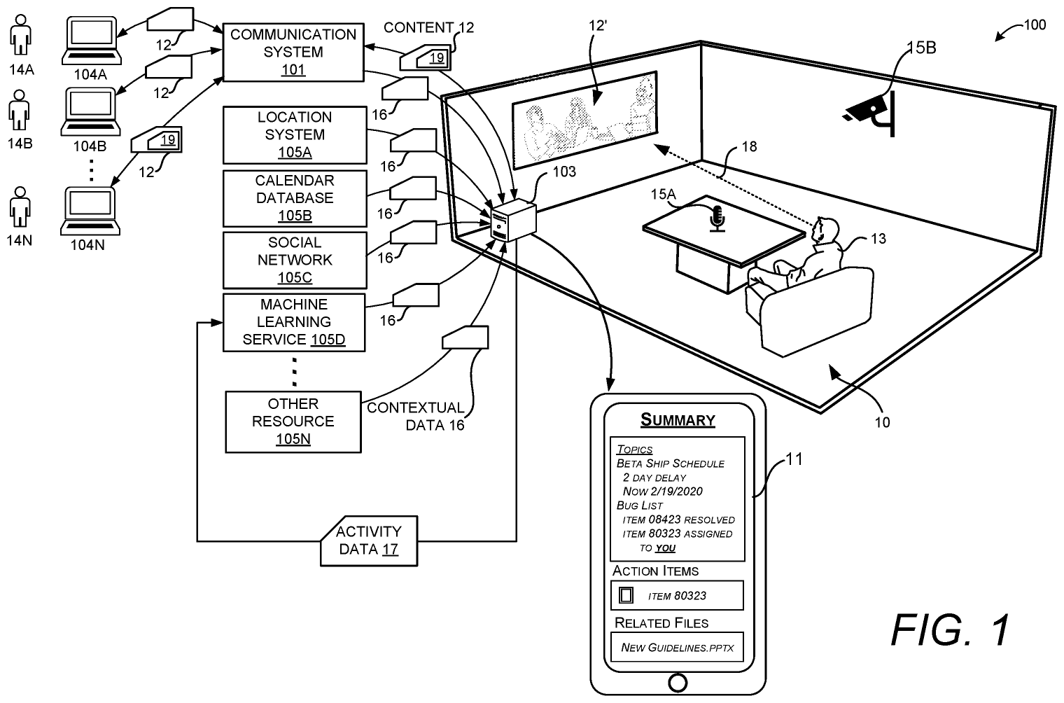

FIG. 1 illustrates an example scenario involving a system 100 for automatically generating a summary 11 of shared content 12 based on a level of engagement of a user 13. The system 100 can automatically generate a summary 11 of any content 12 the user 13 may have missed during a time period that the user 13 was not engaged with a particular event. For example, if a person becomes distracted or is otherwise unavailable during a portion of a presentation, the system 100 can determine a time when the person was unavailable and provide a summary 11 of salient portions of the presentation that occurred during the time the user was distracted. The system 100 can use sensors 15 and contextual data 16 from a number of resources 105 to detect whether a user 13 has engaged in a side conversation, stepped out of room 10, engaged in a phone call, etc. The system 100 can also detect periods of unavailability by the use of location information, calendar data, social network data, etc. A summary 11 can provide a description of any key topics, tasks, and files that were shared during the time that the user 13 was unavailable. In more specific examples, a summary can include reports on meetings, salient sections of channel conversations, salient sections of documents, key topics of unread emails, excerpts of a transcript of a presentation, salient sections of a shared video, etc.

In some configurations, the summary 11 can be derived from content 12 shared between the user 13 and a number of other users 14 associated with a number of networked computing devices 104. The content 12 that is shared between the computing devices 104 can be managed by a communication system 101. The communication system 101 can manage the exchange of shared content 12 communicated using a variety of mediums, such as video data, audio data, text-based communication, channel communication, chat communication, etc. The shared content 12 can also comprise files 19 of any type, include images, documents, metadata, etc. The communication system 101 can manage communication session events which may include meetings, broadcasts, channel sessions, recurring meetings, etc.

The system 100 can analyze input signals received from a number of sensors 15 and contextual data 16 from a number of different resources 105 to determine a level of engagement of the user 13. The system 100 can also analyze data received from the communication system 101 to determine a level of engagement of the user 13. Examples of each source of data are described in more detail below.

The sensors 15 can include any type of device that can monitor the activity of the user 13. For instance, in this example, a microphone 15A and a camera 15B may be used by a computing device, such as the first computing device 104A, to generate activity data 17 indicating the activity of the user 13. The activity data 17 can be used to determine a level of engagement of the user 13. When the user's level of engagement drops below a threshold level, a computing device, such as the first computing device 104A, can generate a summary 11 of the shared content 12 during the period of time in which the user does not maintain a threshold level of engagement. In some configurations, the system 100 can determine whether the user 13 has a threshold level of engagement with respect to a particular event. For illustrative purposes, an event can include any type of activity that can occur over a period of time, such as a broadcast, meeting, communication session, conversation, presentation, etc. An event can also include other ongoing activities that utilize different types of mediums such as emails, channel posts, blogs, etc.

In some implementations, audio data generated by a microphone 15A can be analyzed to determine a person's level of engagement. For instance, a conference room 10 may have a number of microphones 15A for capturing various conversations within a room. If a particular user starts to engage in a side conversation during a presentation, the system can determine that the person does not have a threshold level of engagement with respect to the presentation for a particular time period. The system can also utilize audio data generated by the microphone 15A to determine when a user has a threshold level of engagement. For instance, if the user 13 responds to a question or otherwise engages in a dialogue related to an event, such as the meeting, the system may determine that the user has a threshold level of engagement. Thus, as with other embodiments described herein, the system can determine a timeline with a start time and end time. A summary can be generated based on content that was shared or generated between the start time and the end time.

In some implementations, video data generated by the camera 15B can be analyzed to determine the user's level of engagement. The analysis of video data can enable the system 100 to analyze the user's gaze direction 18 to determine if the user is engaged with a particular target. For instance, if the user 13 is participating in a meeting and the user 13 looks at a content rendering 12′ that is shared during the meeting, the system 100 can determine that the user 13 has a threshold level of engagement. However, if the user 13 looks away from the shared content 12 for a predetermined time period, the system 100 can determine that the user 13 does not have a threshold level of engagement. Similarly, if the user 13 closes his or her eyes for a predetermined time period, the system 100 can determine that the user 13 does not have a threshold level of engagement. A summary 11 of the shared content 12 can be generated for the time period in which the user does not have a threshold level of engagement.

These examples are provided for illustrative purposes and are not to be construed as limiting. It can be appreciated that other gestures/factors indicating that the user 13 does not have a threshold level of engagement can be utilized. In addition, it can be appreciated that other gestures indicating a time in which the user 13 does have a threshold level of engagement can also be utilized. For instance, in a situation where the user 13 is looking away from the shared content 12, and the microphone 15A is used to detect that the user 13 is talking about the shared content 12 or another related topic, the system 100 may determine that the user 13 has a threshold level of engagement.

In some implementations, the system 100 can utilize contextual data 16 from one or more communication systems, such the communication system 101 or a mobile network, to determine the user's level of engagement. The contextual data 16 can include video streams, audio streams, recordings, shared files or other content shared between a number of participants of a communication session. The contextual data 16 can be generated by a communication system 101, which may manage a service such as Teams, Slack, Google Hangouts, Amazon Chime, etc. The communication system 101 can also include or be a part of a mobile network, global positioning system, email system, chat system, or channel communication system.

In one illustrative example, if a person is participating in a meeting and that person takes a phone call during the meeting, the system 100 can analyze contextual data 16 received from the communication system 101 to determine that the person does not have a threshold level of engagement with respect to the meeting when that user is participating in the phone call. In another example, the system 100 can analyze contextual data 16 indicating a number of posts with respect to a channel. If a user is engaging with a channel that is not related to the meeting, the system can determine that the person does not have a threshold level of engagement with respect to the meeting. A similar analysis can be applied to chat sessions, texting, emails, or other mediums of communication. When a person has a predetermined level of engagement with a particular communication medium that is not associated with an event, such as a meeting the user 13 is attending, the system can determine that the person does not have a threshold level of engagement for a particular time period and generate a summary of content 12 that was shared during that time period. Various measurements can be utilized to determine whether a person is engaged with a particular communication medium, such as the length of a phone call, a number of texts or posts the user generates, the number of emails the user generates, an amount of data communicated by the user, etc. Any measurement indicating a quantity of communication data generated by the user can be compared to a threshold to determine if there is a threshold level of engagement.

The system 100 can also analyze contextual data 16 received from the communication system 101 to determine that a user 13 does have a threshold level of engagement. The system 100 can analyze any communication data generated by, or received by, the user 13 to determine if the user activities are related to an event. With respect to the example described above, if the user is engaged in a call using a mobile device, and that mobile device is utilized to access content associated with the event, e.g. the meeting, the system may determine that the user has a threshold level of engagement with the meeting. Thus, as with other embodiments described herein, the system can determine a timeline with a start time and end time. A summary can be generated based on content that was shared or generated between the start time and the end time.

In some implementations, the system 100 can utilize contextual data 16 from a location system 105A. The location system 105A can include systems such as a Wi-Fi network, GPS system, mobile network, etc. In one illustrative example, location data generated by a location system 105A can be used to determine that a person was late to a particular meeting or left a meeting early. The location data can also be used to determine the timing of a person stepping out of a meeting temporarily and returning. Such information can be used to generate a summary of content 12 that was shared or generated during a time period the user was not in attendance.

In some implementations, the system 100 can utilize contextual data 16 from a calendar database 105B. The calendar database can include any type of system that stores scheduling information for users. The system 100 can analyze the scheduling data with respect to the user 13 to determine if the user has a threshold level of engagement. For instance, a user's calendar data may indicate that the user has declined a meeting request. Such data can cause the system 100 to generate a summary 11 based on content 12 that was shared during that meeting. In another example, the system can analyze the scheduling data of a user to determine if the user is out of the office or otherwise unavailable. Such data can cause the system 100 to generate a summary 11 based on content 12 that was shared during a period in which the user was unavailable.

Location data can also be utilized in conjunction with other information such as scheduling data to determine if the user has a threshold level of engagement with respect to an event. For instance, a user's scheduling data can indicate a listing of two conflicting meetings at different locations. The system can analyze the user location data to determine which meeting the user attended. The system can then generate a summary based on content that was shared in the meeting the user was unable to attend.

Contextual data 16 from a social network 105C can also be utilized to determine a user's location and schedule. This data can be utilized to determine when the user has a threshold level of engagement with respect to an event. The system can then generate a summary based on content for a particular event for which the user did not have a threshold level of engagement.

Contextual data 16 received from a machine learning service 105D can also be utilized to determine a user's level of engagement with respect to an event. A machine learning service 105D can receive activity data 17 from one or more computing devices. That activity data can be analyzed to determine activity patterns of a particular user and such data can be utilized to determine a threshold level of engagement with respect to an event. For example, if location data received from a mobile network does not have a high confidence level, the system 100 may utilize contextual data 16 in the form of machine learning data to determine a probability that a user may attend an event. In another example, the machine learning service 105D may analyze a user's calendar data to determine that user has historically attended a recurring meeting. Having such data, the system 100 may determine that the user has a threshold level of engagement with a current meeting even though other data, such as the user location data cannot confirm the user is in a predetermined location confirming their attendance.

The system can also utilize a direct input from the user indicating their level of engagement. For instance, a user can state that they “will be right back” or that they “have returned.” One or more microphones can detect such statements and determine a start time or an end time for a timeline of a summary. Other forms of manual input can be utilized to determine a user's level of engagement. For instance, a quick key, particular gesture, or any other suitable input can be provided by any user to determine a start time or an end time for a timeline of a summary.

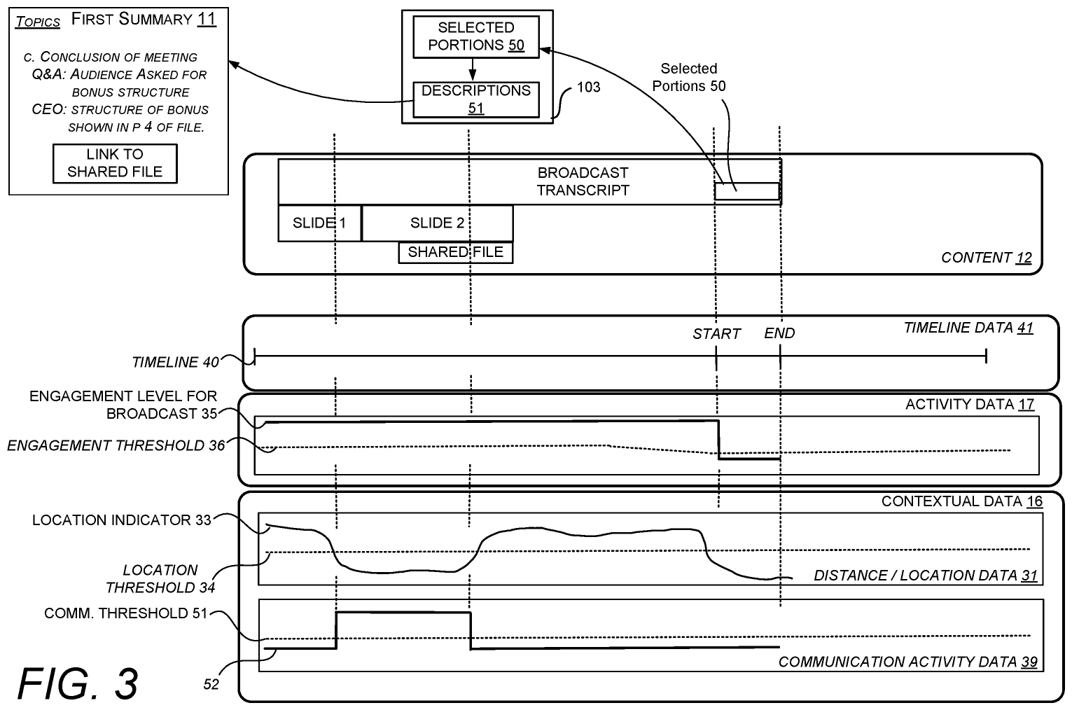

Any type of contextual data or activity data can be communicated to a machine learning service 105D for the purposes of making adjustments to any process described herein. In some circumstances, contextual data and/or activity data can be communicated to a machine learning service 105D to cause the generation of one or more values that can be used to adjust a threshold. For instance, generation of too many false values with respect to engagement level can cause a system to increase or decrease one or more thresholds described herein. It can also be appreciated that the thresholds change over time with respect to an event. Examples of such an embodiment is described in more detail below and illustrated in FIG. 3.

These examples are provided for illustrative purposes and are not to be construed as limiting. The system 100 can utilize any type of contextual data 16 that describes user activity received from any type of resource 105. Further, the contextual data 16 utilized to determine a user level of engagement can come from any suitable resource or sensor in addition to those described herein. It can also be appreciated that contextual data 16 from each of the resources 105 described herein can be used in any combination to determine a user's level of engagement with respect to any event. In some embodiments, a person's scheduling data can be analyzed alone or in conjunction with other contextual data. Such implementations can enable a system to analyze or confirm long periods of disengagement, such as vacations, off-site meetings, etc.

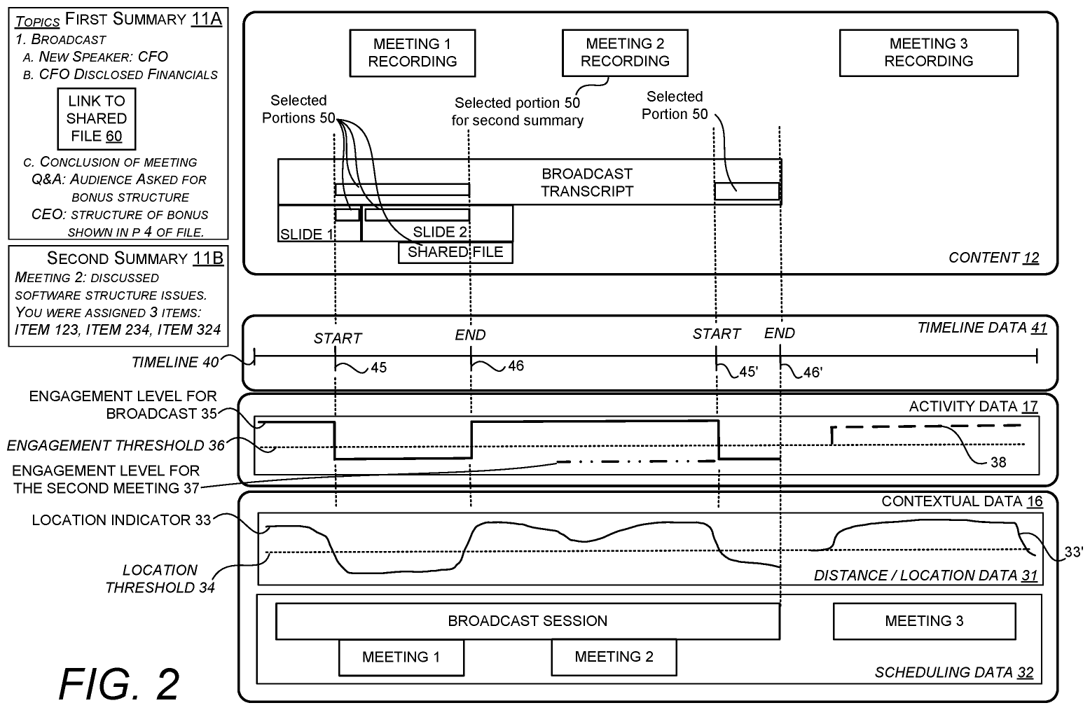

FIG. 2 illustrates one illustrative example of how contextual data 16 from a number of different sources can be utilized to determine a timeline 40 that defines parameters for a summary 11. Generally described, a timeline 40 can indicate a start time and an end time. The system can use the start time and end time to determine which portions of the content 12 is to be selected for inclusion in a summary 11.

In this example, the contextual data 16 includes distance/location data 31 and scheduling data 32. The scheduling data 32 indicates that the user 13 has four events: a broadcast session, a first meeting (meeting 1), a second meeting (meeting 2), and a third meeting (meeting 3). During the broadcast session, different types of content are shared between computing devices. In this example, a broadcast transcript, a first slide deck (Slide 1) and a second slide deck (Slide 2) are shared. In addition, the presenter of the broadcast also shared a file (Shared File) with a number of computing devices associated with the broadcast session. During the first meeting, second meeting, and the third meeting, audio recordings (Meeting 1 Recording, Meeting 2 Recording, and Meeting 3 Recording) from each meeting are generated and shared with the attendees. As described in more detail below, the content 12 associated with each event can be parsed and portions of the content 12 can be used for generating a summary 11.

In some configurations, the system 100 maintains a value, referred to herein as a location indicator 33, that indicates a relative location of the user 13 with respect to a particular event. In this specific example shown in FIG. 2, the location indicator 33 indicates a location of the user 13 relative to a location of the broadcast session. In this example, a higher value of the location indicator 33 indicates that the user is close to the location of the broadcast session, and a lower value of the location indicator 33 indicates that the user is further from the location of the broadcast session.

As shown, the location indicator 33 is above a location threshold 34 at the beginning of the broadcast session. Since the location indicator 33 is above the engagement threshold 36, the system can determine that the user is engaged with the event and the system does not select any of the shared content 12 for inclusion in the summary.

In this example, the drop in the location indicator 33 indicates that the user 13 has moved from the location of the broadcast session. In a situation where the location indicator 33 drops below the location threshold 34, e.g., the user has moved beyond a threshold distance from a location of an event, the system determines that the engagement level 35 for the user with respect to the broadcast session has dropped below the engagement threshold 36. Then, when the user returns to the location of the broadcast session, as shown by the location indicator 33 rising above the location threshold 34, the system can determine that the level of engagement 35 for the broadcast session is at a value above the engagement threshold 36.

As the level of engagement 35 drops below the threshold 36, the system 100 can generate timeline data 41 indicating a start time. Similarly, as the level of engagement increases above the threshold 36, the system can generate timeline data 41 indicating an end time. The start time and end time can be used to select portions 50 of the content 12 for inclusion in a summary 11. As shown, selected portions 50 of the shared content 12 can be selected based on the start time and the end time the user's level of engagement 35 drops below the threshold 36. For illustrative purposes, the selected portions 50 can also be referred to herein as selected segments. In this example, a portion of the first slide (slide 1), a portion of the second slide (slide 2), and a portion of the broadcast transcript can be selected for the purposes of generating a first summary 11A that is associated with the broadcast. In this example, the selected portions 50 of the content 12 include the shared file. In such scenarios, the entire shared file can be selected for inclusion in a summary.

In this example, the location indicator 33 also indicates that the user 13 left the broadcast session early. In such a scenario, the system can generate a second start time 45′ and a second end time 46′ for the purposes of selecting additional portions 50 of the content 12 for inclusion in the summary 11.

The selected portions 50 can be parsed from the content 12 such that the content within the start time and the end time is used to generate the first summary 11A. As shown, the first summary 11A includes a number of topics and details about the broadcast session. A system can generate or copy a number of sentences describing the selected portions 50 of the shared content 12. As also shown, a summary, such as the first summary 11A, can include at least one graphical element 60 configured to provide access to one of the shared files 60, e.g., a link for causing a download or display of any shared file 60.

Also shown in FIG. 2, in this example, the system can also derive activity data indicating an engagement level for the second meeting (meeting 2). Given that the user location remained above a threshold with respect to the broadcast session, the user location with respect to the second meeting is determined to be below a threshold. Thus, the system, in this example, can generate activity data (not shown) indicating that the user did not have a threshold level of engagement with respect to the second meeting. Given that the user did not have a threshold level of engagement with respect to the second meeting, the system can generate another summary, such as the second summary 11B for content that was shared during the second meeting. In this example, the shared content of the second meeting includes a recording of the meeting. In such an example, the system can transcribe portions of the meeting recording and generate descriptions of salient portions of the meeting recording.

Salient portions of the content 12 can include the portions of content that identify tasks associated with a user and descriptions of key topics having a threshold level of relevancy to the user activities. In some configurations, the content 12 can be analyzed and parsed to identify tasks. Tasks can be identified by the use of a number of determine keywords such as “complete,” “assign,” “deadline,” “project,” etc. If a sentence has a threshold number of keywords, the system can identify usernames or identities in or around the sentence. Such correlations can be made to identify a task for individual and a summary of the task can be generated based on a sentence or phrase identifying the username and the keywords. Key topics having a threshold level of relevancy to user activities can include specific keywords related to data stored in association with the user. For instance, if a meeting recording identifies a number of topics, the system can analyze file stored in association with individual attendee. If of stored file such as a number of documents associated with a particular user are relevant to a topic raised during the meeting, that topic may be identified as a key topic for the user and a description of the topic may be included in a summary for that user.

As shown in FIG. 2, a location indicator 33′ indicates a location of the user 13 relative to a location of the third meeting (meeting 3). In the example, the user's location causes the system to determine that the user had a level of engagement 38 for the third meeting (meeting 3) that exceeded the engagement threshold 36. Thus, the system did not generate a summary for the third meeting. In this example, it is a given that the user 13 left the location of the broadcast session to attend the first meeting (meeting 1), thus the system did not generate a summary for the first meeting.

The delivery of the summary can be in response to a number of different factors. For instance, a summary, or sections of a summary, can be delivered to a user 13 when their level of engagement exceeds, or returns to a level above, a threshold. For example, a summary may be delivered when the user 13 returns to a meeting after leaving momentarily. In another example, a summary, or sections of a summary, can be delivered to a user in response to a user input indicating a request for the summary or an update for the summary. In some configurations, sections of a summary can be updated in real time during an event. For instance, in the example of FIG. 2, when the user leaves the broadcast session to attend the first meeting, the system can send salient portions of the broadcast session as the content is shared within the broadcast session. This enables the user to monitor the progress of the broadcast session in real time. If the user identifies a topic of interest, this embodiment can an able the user to return to the broadcast session. Real-time updates for each event can help a user multitask and prioritize multiple events as the events unfold. The real time updates also allow a user to respond to key items in a timely manner.

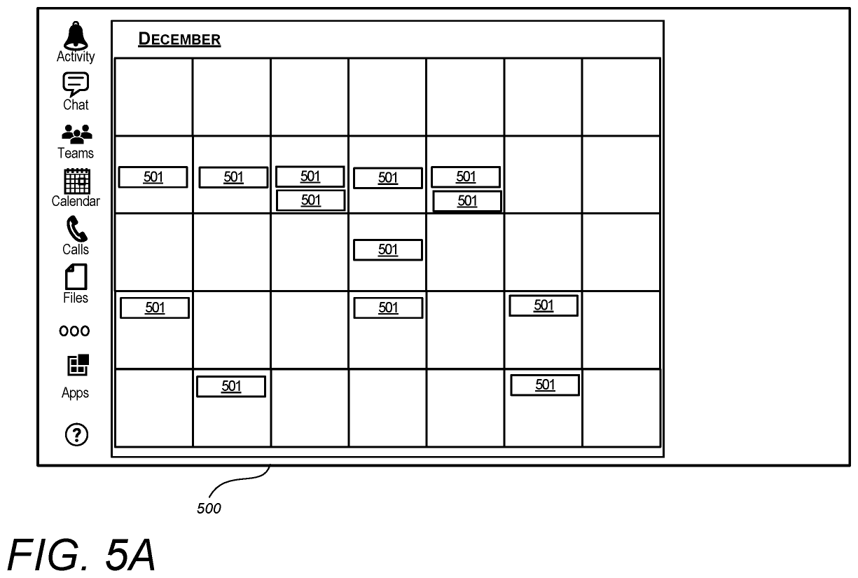

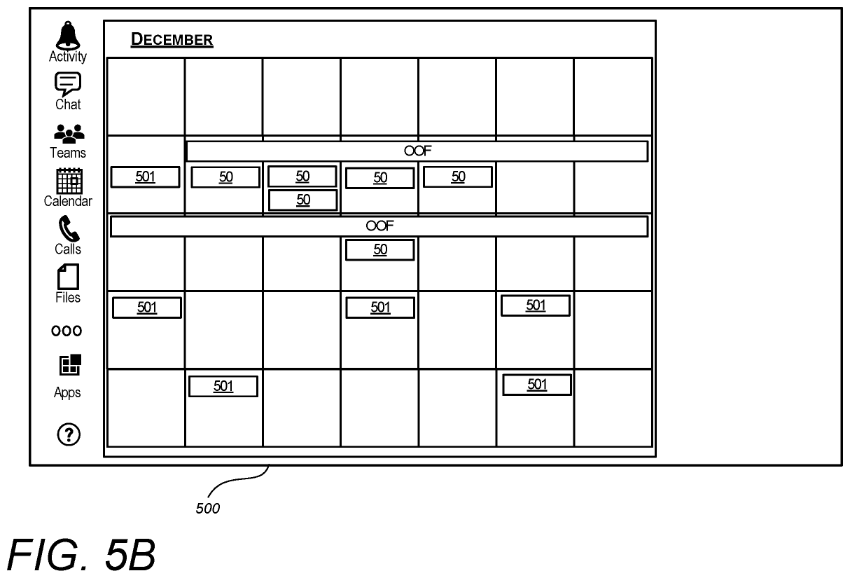

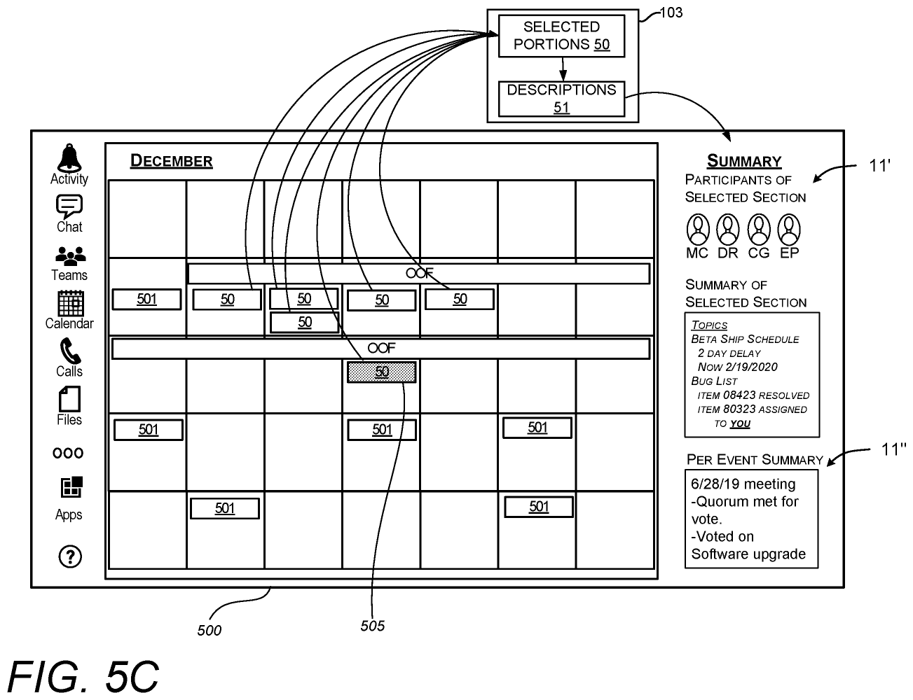

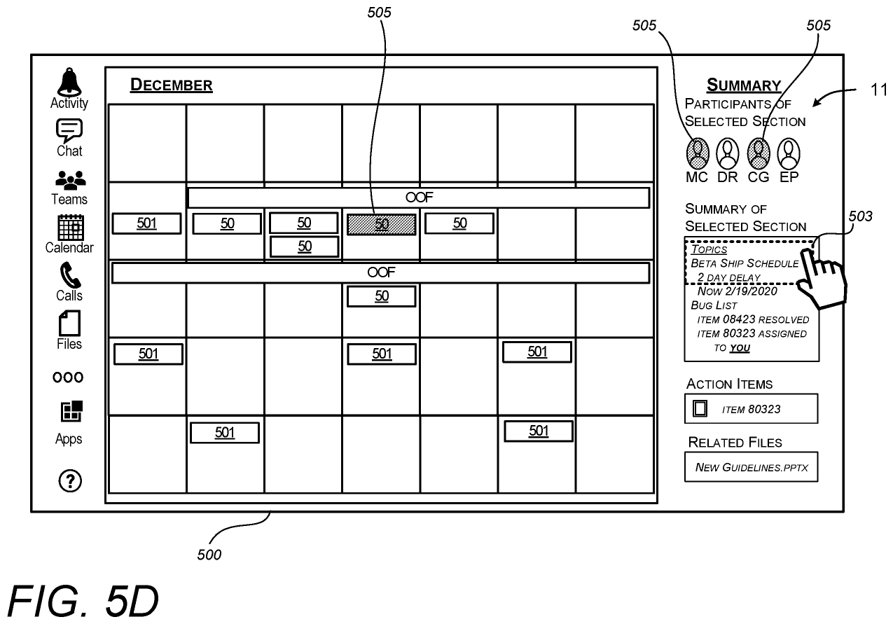

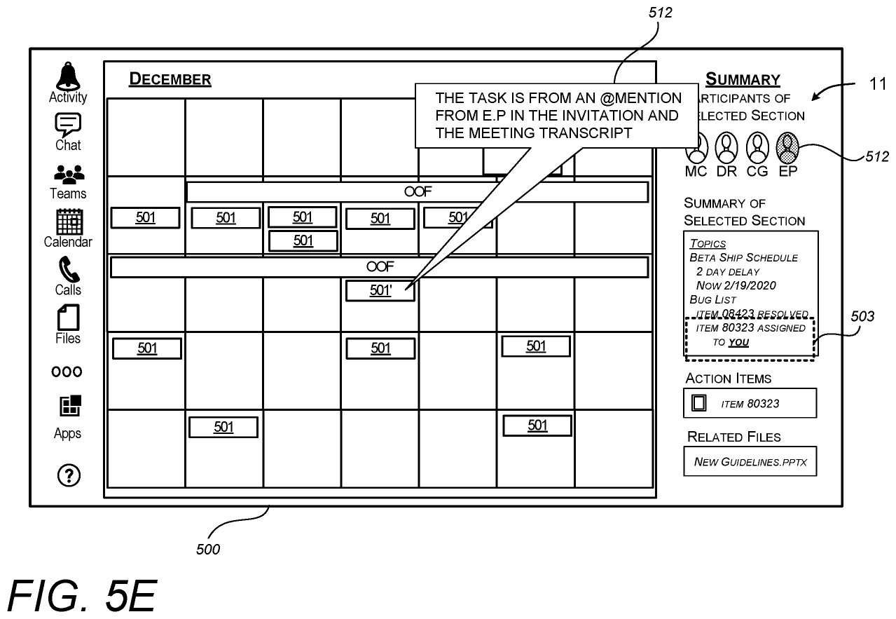

A summary or sections of a summary can be delivered to a person before an event, during the event, or after the event. A summary delivered before an event can be based on an indication that the user will not be available, e.g., an out of office message or a message indicating they declined a meeting invitation. Content that is shared before the event, such as an attachment to a meeting request, can be summarized and sent to a user prior to the event. A summary delivered during an event is described above, in which a user can receive key points of an event as they are occurring. A comprehensive summary can also be delivered after an event in a manner described above with respect to the example of FIG. 2, or a series of events such as the example shown in FIG. 5A through FIG. 5E.

FIG. 3 illustrates another example scenario where different types of contextual data are utilized to determine the level of engagement for a user. In this example, a combination of distance/location data 31 and communication activity data 39 are utilized. As described herein, the location data 31 can be received from any type of system that can track the location of a computing device associated with the user. This can include a Wi-Fi network, a mobile network, or other sensors within a device such as accelerometers. The communication activity data 39 can be received from any type of system such as a network, a communication system, a social network, etc.

In this example, the user 13 is attending a broadcast session. During the broadcast session, different types of content are shared between computing devices. In this example, a broadcast transcript, a first slide deck and a second slide deck are shared. In addition, the presenter of the broadcast also shared a file with a number of computing devices associated with the broadcast session.

As shown by the location indicator 33, in this example, the user 13 leaves the location of the broadcast just before the presentation transitions from the first slide to the second slide. At the same time, the communication activity data 39 indicates that a level of communication 52 associated with the broadcast increases above a communication threshold 51. Given this combination of contextual data, the user engagement level for the broadcast 35 remains above the engagement threshold 36. The system can consider both types of contextual data to determine an engagement level. In the specific scenario, even though the user may step out of the meeting, the system can still determine that the user is engaged with the broadcast given that they are engaging with the device that receives information related to the event.

In this example, later in the broadcast session, the user leaves the location of the broadcast session and does not engage with any communication activity associated with the event. In this instance, the system determines that the user level of engagement for the broadcast 35 drops below the engagement threshold 36 thus initiating the generation of a start time for the timeline 40. In response to this activity, the system can then generate a summary 11 for the selected portions 50 of the content 12 that the user missed during the time they were not at a threshold level of engagement, e.g., not engaged with the broadcast session.

As shown, the summary includes information related to the conclusion of the broadcast session. In addition, the summary 11 includes a link to a shared file even though the shared file was not presented during the time that the user was not engaged with the broadcast. Thus, exceptions can be made for the inclusion of certain content 12 in a summary. In some configurations, certain types of content 12 can be selected for inclusion in the summary based on the content type. For instance, videos, documents, spreadsheets can all be included in a summary notwithstanding the start time in the end time of the timeline 40.

As summarized above, some embodiments described herein can enable the system to adjust one or more thresholds based on machine learning data. For instance, if the system 100 determines that a history of user activity causes the system to generate a number of summaries during a period where the user was actually engaged in an event, the system can analyze patterns of user activity and cause the system to adjust the threshold, such as the engagement threshold 36 shown in FIG. 3.

In some configurations, image data or video data generated by a camera or a sensor can be analyzed to determine a person's level of engagement. The analysis of video data can enable a system to analyze a person's gaze gestures to determine engagement within a particular target. For instance, if a user is participating in a meeting and the person looks at their phone for a predetermined time period, the system can determine that the person does not have a threshold level of engagement. Similarly, if the user's eyes are closed for a predetermined time period, the system can determine that person does not have a threshold level of engagement.

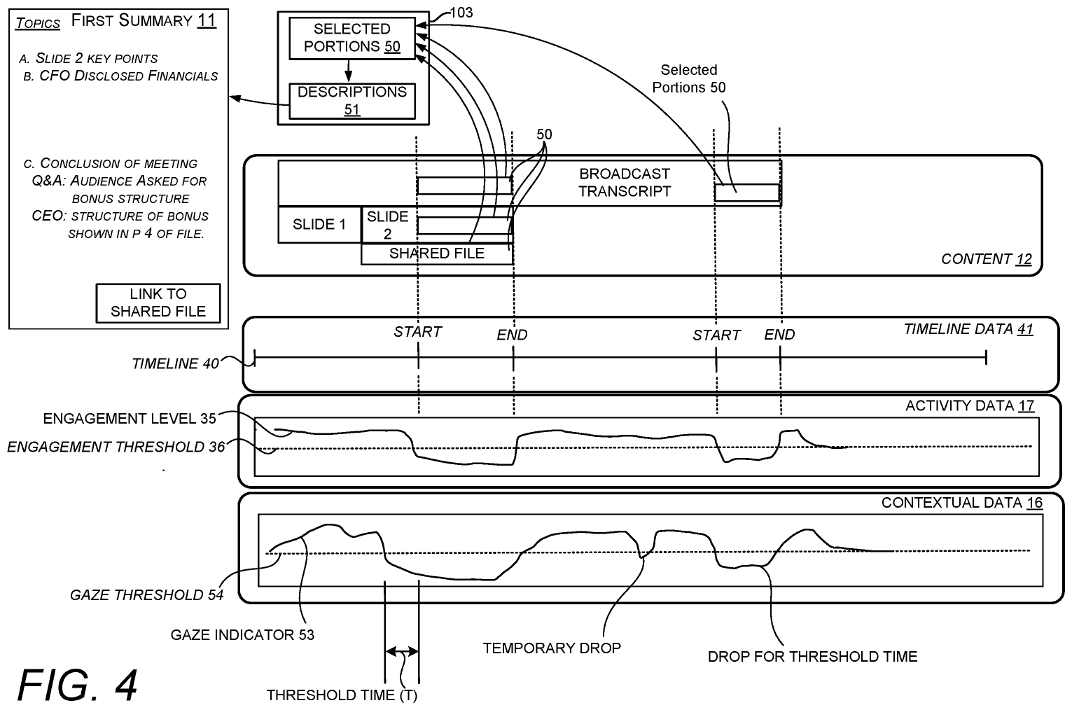

FIG. 4 illustrates another example scenario where contextual data 16 defining a gaze gesture (18 of FIG. 1) is utilized to determine the level of engagement for a user. In this example, the contextual data 16 defines a value of a gaze indicator 53 over time. The gaze indicator 53 indicates a location of the user's gaze gesture relative to a display of any shared content 12, such as the projection of the content 12 shown in FIG. 1. When the user is looking at the display of the content 12, the value of the gaze indicator 53 increases. When the user is looking away from the display of content 12, the value of the gaze indicator 53 decreases. In this example, the system can cause a value of the engagement level 35 to track the value of the gaze indicator 53. When the value of the gaze indicator 53 drops below the gaze threshold 54, the system can control the value of the engagement level 35 to also drop below the engagement threshold 36. At the same time, when the value of the gaze indicator 53 increases above the gaze threshold 54, the system can control the value of engagement level to increase above the engagement threshold 36.

The system can also utilize a number of conditions to avoid the generation of false-positive and false-negative readings. For instance, as shown in FIG. 4, when the value of the gaze indicator 53 has a temporary drop below the gaze threshold 54, e.g., a drop less than a threshold time, the system does not cause the engagement level 35 to drop below the engagement threshold 36. However, when the value of the gaze indicator 53 drops below the gaze threshold 54 for at least a predetermined time, the system can control the value of the engagement level 35 to also drop below the engagement threshold 36.

In response to determining the periods of time where the user did not have a threshold level of engagement, as indicated by the start time and end time markers of the timeline 40, the system then generates a summary 11 for the selected portions 50 of the content 12 that the user missed during the time the user was not at a threshold level of engagement. As shown, the summary 11 includes information related to the second slide (slide 2), the shared file, and parts of the broadcast transcript that are associated with times between the start and end time markers. In addition, the summary 11 includes a link to a shared file.

FIG. 5A through 5E illustrate another example scenario where a system 100 can utilize scheduling data for a user to determine if the user has a threshold level of engagement. In this example, a user's level of engagement can be indicated by one or more events defined by scheduling data. As will be described in more detail below, the system determines a user level of engagement across a number of events and retrieves data associated with select events to generate a summary.

In this example, as shown in FIG. 5A, a user's scheduling data indicates a number of events 501 scheduled at different dates and times. In FIG. 5B, a user input or receipt of other contextual data can cause a system to populate the scheduling data with one or more entries indicating the unavailability of a person. In this case, a graphical element, labeled as “OOF,” indicates a number of days that the person is unavailable.

In response to the entries, as shown in FIG. 5C, the system can select certain events that align with times and days the person is unavailable. Select portions 50 of data associated with the selected events 501 are used to generate one or more descriptions 51. The descriptions 51 can include direct quotes from data associated with the select portions 50, such as files or data streams that were shared during the events. The descriptions can also include computer-generated descriptions, i.e., a set of computer-generated sentences, that summarize the data associated with the select portions 50. The descriptions 51 can be used to generate the summary.

FIG. 5C also shows an illustrative embodiment where multiple layers of the summary can be generated. In this example, a comprehensive summary 11′ is generated to show salient content for all events that were missed. In addition, the system can generate a per event summary 11″. In this example, a graphical element 505 can also be generated to bring highlight to the event associated with the per event summary 11″. Individual events may be identified for a per event summary 11″ based on a ranking of topics associated with each event. The topics may be ranked based on the user activity with respect to that topic. As described in more detail below, topics can be ranked and prioritized based on the user interaction with the summary and/or other user activity. For instance, a user's emails or other communication showing an interest in a particular topic can contribute to a priority of a number of topics, and in turn, those topics can be used to rank and select specific events for a per event summary 11″. Also shown in FIG. 5C, one or more graphical elements, such as a highlight, can be generated to identify one or more event participants (listed as MC, DR, CG, and EP) that are associated with the event associated with one of the summaries. In this example, the participant listed as DR is highlighted to show an association with the event associated with the second summary 11″.

In some configurations, the summary 11 can be displayed on a user interface 500 configured to receive a selection of a portion of the summary. The selection of the portion of the summary can cause the system to highlight one or more events related to the selected portion(s) of the summary. For example, as shown in FIG. 5D, a user selection of a portion 503 of the summary 11 can cause the system to generate a graphical element or highlight 505 to draw focus to an event that is related to the selected portion 503 of the summary 11. The graphical element or the highlight 505 can also bring focus to entities, e.g., participants of an event, that are associated with the portion of the summary.

In some embodiments, as shown in FIG. 5E, the system can automatically select a portion of a summary 11 that is associated with the user. For instance, if a summary includes a task assigned to a particular user, the system can select that task and automatically generate a graphical element 503 to draw attention to the selected section. In addition, the system can generate a notification 512 or another graphical element drawing user focus to specific events 501′ from which the task originated. In this example, a particular event 501′ is highlighted with a notification 512. The event 501′ can be identified by the use of any portion of shared content associated with an event, such as a meeting invitation or a transcript of the meeting, that mentioned the task and/or the associated user.

In this example, the task is included in the summary 11 in response to the inclusion of an “@mention” for a user in the calendar event 501′. In addition, the transcript of the meeting includes text indicating the task as being associated with the user. Given that the task is associated with the event 501′, as shown in FIG. 5E, when the user is viewing the summary 11, the system generates a notification 512 indicating that the source of the task is the event 501′. The system can also cause a display of a graphical element or a highlight 505 that can bring focus to one or more entities, e.g., participants of an event, that are associated with sections of the summary. This example is provided for illustrative purposes and is not to be construed as limiting. It can be appreciated that other forms of graphical elements or other forms of output, such as a computer-generated sound, can be used to draw focus to particular event.

In some embodiments, a summary may include computer-generated sections and other sections that are direct quotes of the selected content. A user interface can graphically distinguish the computer-generated sections from the other sections that are direct quotes of the selected portions 50 of the content 12. For instance, if a summary 11 includes two computer-generated sentences describing selected portions 50 of the content 12 and three sentences that directly quote portions 50 of the content 12, the two computer-generated sections of the summary may be in a first color and the other sentences may be in a second color. By distinguishing quoted sections from computer-generated sections, the system can readily communicate the reliability of the descriptions displayed in the summary 11.

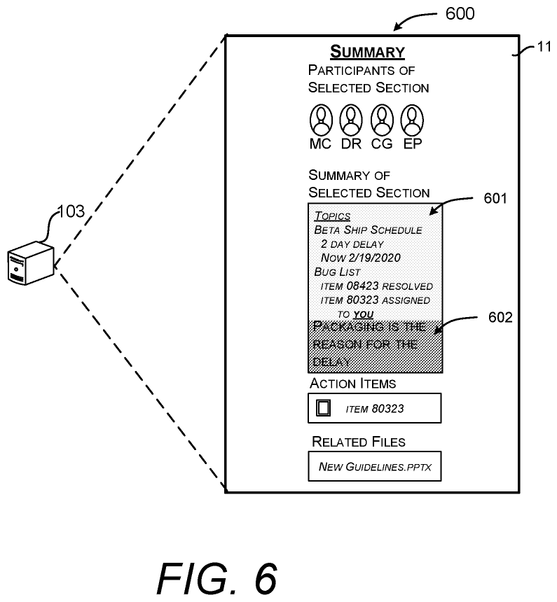

FIG. 6 illustrates one example of a user interface 600 that comprises a first graphical element 601 that distinguishes the computer-generated sections of the content 12 from the quoted sections of the content 12. This example includes a second graphical element 602 that indicates the sections of the summary that are direct quotes of the selected segments. In this example, the graphical elements are in different shades to distinguish the two types of summaries. This example is provided for illustrative purposes and is not to be construed as limiting. It can be appreciated that other graphical elements can be used to distinguish the computer-generated sections from the quoted sections. Different colors, shapes, fonts, font styles, and/or text descriptions can be utilized to distinguish the sections.

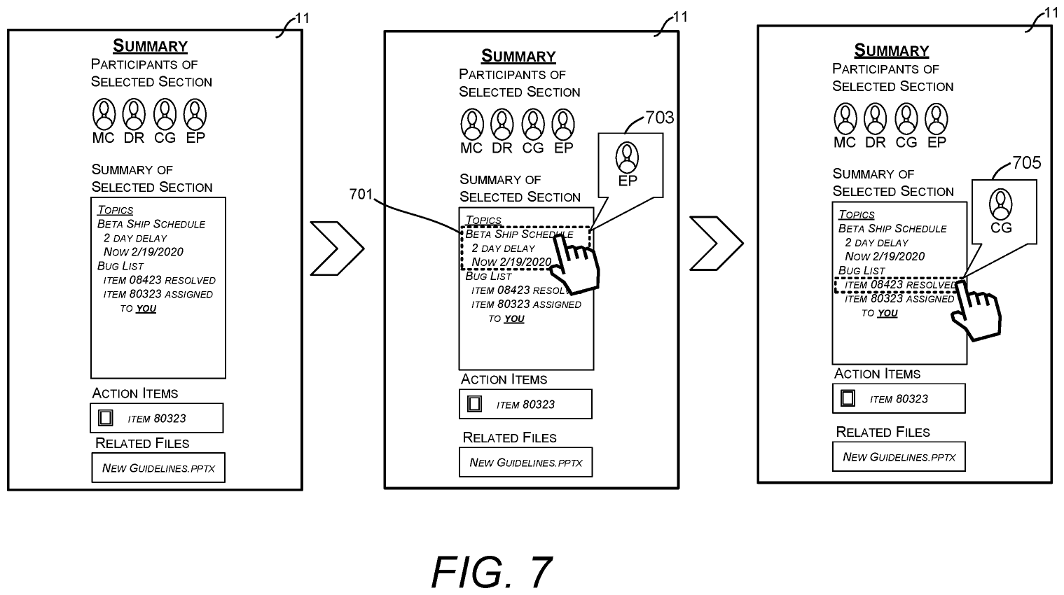

In some configurations, a user interface of a summary can also include a number of graphical elements indicating a source of information included in the summary. Such graphical elements can identify a user that provided the information during an event or a system that provided the information. FIG. 7 illustrates an example of a summary 11 that provides graphical elements revealing a source of information. In this example, the summary 11 transitions from a first state (left) to a second state (middle) when a user selects a section 701 of the summary 11. In this example, the selected section 701 describes a “beta ship schedule.” In response to the selection, the system causes the summary 11 to include a graphical element 703 indicating a user identity that contributed to the content of the selected section.

The display of the summary 11 transitions from the second state (middle) to a third state (right) when a user selects another section of the summary. In this example, the newly selected section, describing “item 08423,” is highlighted. In addition, in response to the selection, the system causes the display of the summary 11 to include another graphical element 705 indicating a user identity that contributed to the content of the newly selected section.

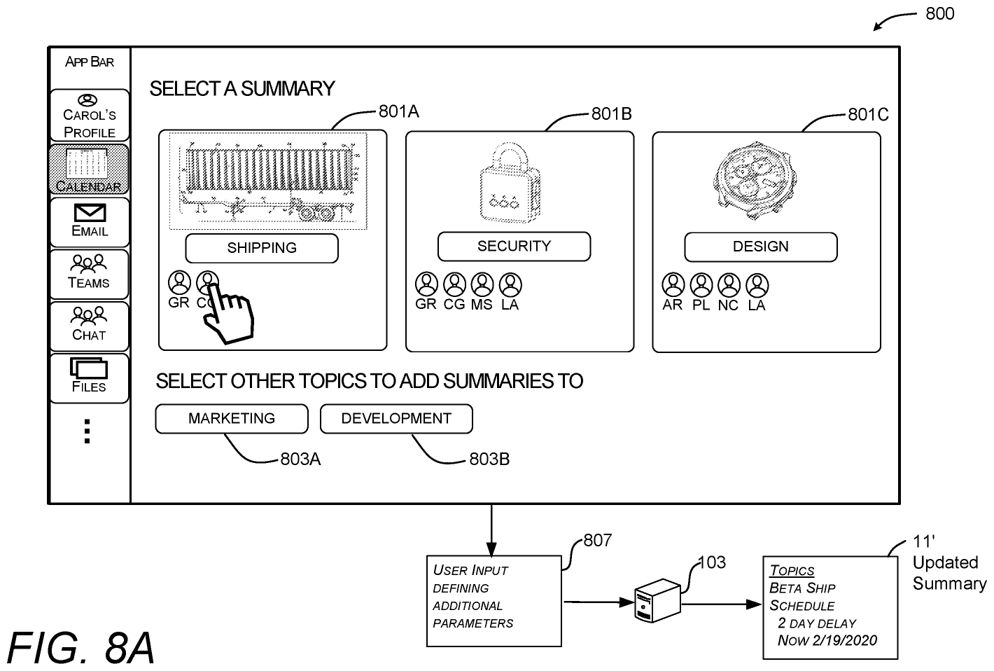

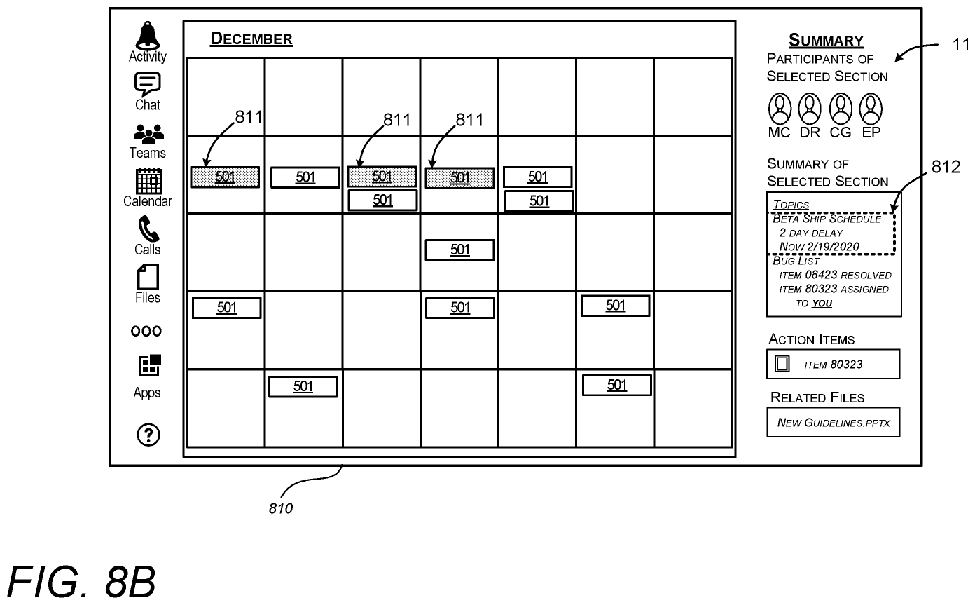

FIG. 8A illustrates an example of a user interface 800 displaying a number of graphical elements 801 representing summaries 11 based on different topics. In this example, a first summary associated with the first element 801A is about “shipping,” a second summary associated with the second element 801B is about “security,” and a third summary associated with the third element 801C is about “design.” Each summary can be based on different events.

In some configurations, the system can prioritize topics of each summary based on a user's interaction with a summary. For instance, a user's selection or review of any one of the summaries of FIG. 8A, e.g., “shipping,” “security,” or “design,” can cause the system to prioritize the summaries and/or topics of the summaries. A selection of a particular summary can be used as an input to a machine learning service to indicate that a particular summary has a higher priority than the other summaries. Such data can be communicated back to the system 100 for the purpose of updating machine learning data. This way, the system can generate summaries in the future with a heightened level of priority for topics that were previously selected by a user. If the user selects a number of different summaries, the order in which the summaries are selected can used to determine a priority for a summary and/or a topic. For instance, a first selected summary can be prioritized higher than a second selected summary. A topic or an event related to the selected summary can be used to determine whether the system generates summaries for related events or topics.

In one specific example, in response to a selection of a summary, the topic of the summary and other supporting keywords can be sent back to a machine learning service (105D of FIG. 1) to update machine learning data. The machine learning service can then increase a priority or relevancy level with respect to the selected topic and the supporting keywords for the purposes of improving the generation of future summaries. In addition, a priority for a particular topic can cause the system to arrange a number of summaries based on the priority of a topic.

The machine learning data that is collected from the techniques disclosed herein can be used for a number of different purposes. For instance, when a person interacts with a summary, such interactions can be interpreted by the machine learning service to sort, order or arrange descriptions, e.g., the sentences, of a summary. The user interactions can be based on any type of detectable activity and communicated in the activity data (17 of FIG. 1). For instance, a system can determine if a user reads a summary. In another example, a system can determine if a person has a particular interaction with the user interface displaying the summary, e.g., they selected a task within the summary, opened a file within the summary, etc. If a particular arrangement of sentences proves to be useful for a number of users, that arrangement of sentences may be communicated to other users to optimize the effectiveness of the committee case summaries.

Also shown in FIG. 8A, the user interface 800 displays a number of selectable interface elements 803 that display topics. These topics may come from keywords discovered in the selected portions 50 of the content 12, where the keywords did not meet a condition. For instance, if the number of occurrences of the keywords did not reach a threshold, instead of generating a summary on the topics indicated by the keywords, the system may instead cause a graphical display of the topics. A user selection of those displayed topics can allow a person to increase or decrease the priority of the topics, and activity data defining such activity can be used to change the way summaries are generated and/or displayed.

For example, in response to a user selection of a selectable interface element 803A, e.g., the “Marketing” button 803A or the “Development” button 803B, the system 100 can generate summaries about those topics using keywords or sentences found in proximity to the selected topic. For instance, if a number of entries of a channel contain the word “Marketing,” keywords in the same sentence as the word “Marketing” can be used to generate a summary. In addition, full sentences may be quoted from a particular channel entry and used for at least a part of a generated summary.

In response to a selection of a topic, the system may send data defining that topic to a machine learning service to update machine learning data. The machine learning service can then increase a priority or relevancy level with respect to the selected topic and the supporting keywords for the purposes of improving the generation of future summaries.

Generally described, the techniques disclosed herein, some of which are shown in FIG. 8A, can allow a user to refine the parameters that are used to generate a summary. Some embodiments enable the system 100 to identify more than one topic to generate a summary. For instance, a summary may include two topics, both of which involve a number of usernames. If the summary appears to be too broad, a user viewing the summary can narrow the summary to a single topic or specific individuals. For instance, by the use of a voice command or any other suitable type of input 807, a user can cause the system 100 to generate an updated summary 11′ by adding parameters to refine the summary to a preferred topic, a particular a person, or a specific group of people. This can allow users to have further control over the level of granularity of the summary. This may help for very large threads that may have multiple topics. In addition, this type of input can be provided to a machine learning service to improve the generation of other summaries. For instance, if a particular person or a topic is selected a threshold number of times in the input 807, a priority for that particular topic or person can be increased which can make that person or topic more prevalent in other summaries.

In addition to updating a summary based on a user interaction for selecting a topic, the selection of a topic can also be used to update a list of events. FIG. 8B illustrates one example of a user interface 810 displaying a list of events 501. In this example the user interface 810 comprises a summary 11 that is modified based on a user interaction.

For illustrative purposes, consider a scenario where the user has selected the “Shipping” summary shown in FIG. 8A. Based on such a selection, the system can display the summary of FIG. 8B where a highlight 812 is generated to draw attention to summary items related to a topic of the selected summary. In addition, the user interface 810 displays highlights 811 to draw a user's attention to events 510 that were the source of the summary items.

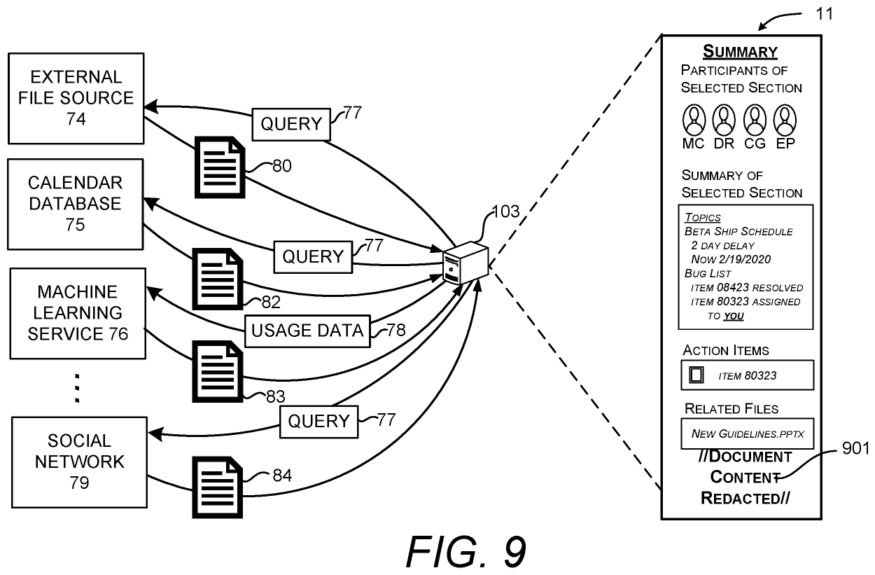

FIG. 9 illustrates how a system can interact with a number of different resources to generate a summary. In some embodiments, a system 100 can send a query 77 to an external file source 74 to obtain a document 80 that is referenced in a selected portion of content. The query can be based on information received from the originating source of portion 50 (as shown in FIG. 2) of content 12 (as shown in FIG. 1), e.g., a channel related to a meeting or a transcript of a presentation. In addition, the system 100 can send another query 77 to a calendar database 75 to receive calendar data 82. Such information can be utilized to identify dates and other scheduling information that may be utilized to generate a summary. For instance, if a particular deadline is stored in the calendar database 75, a query can be built from the content of one or more selected segments and the calendar database 75 can send calendar data 82 to confirm one or more dates. As also described herein, the system 100 can send usage data 78 to one or more machine learning services 76. In response, the machine learning service 76 can return machine learning data 83 to assist the system 100 in generating a summary. For instance, a priority with respect to certain keywords can be communicated back to the system 100 to assist the system in generating a relevant summary with a topic that is most relevant to a conversation or a selected portion 50 of content 12. The system 100 can also access other resources, such as a social network 79. For instance, if the portion 50 of content 12 indicates a first and last name of a person, additional information 84 regarding that person, such as credentials or achievements, can be retrieved for integration and generating a relevant summary.

In some configurations, the techniques disclosed herein can access permissions with respect to various aspects of a summary and control the content of the summary based on those permissions. For instance, the system 100 can determine if permissions of a portion 50 of content 12 are restricted, e.g., a file shared during a presentation is encrypted with a password. If it is determined that permissions with respect to a file or any portion 50 of content 12 is restricted, a system can limit the amount of disclosure of a summary that is based on the file or the retrieved content. FIG. 9 illustrates an example of such a summary. Instead of listing the contents of the document, New Guidelines.pptx, the summary of the example of FIG. 9 provides an indicator 901 that indicates portions of the contents of the file are restricted and have been redacted.

The detected permissions can also change the content for a summary on a per-user basis. For instance, if a first user has full access permissions to a file and a second user has partial access permissions to the same file, a summary displayed to the first user may include a full set of sentences generated for that summary. On the other hand, a system may redact a summary that is displayed to the second user and only show a subset of sentences or a subset of content if the permissions to that user are limited.

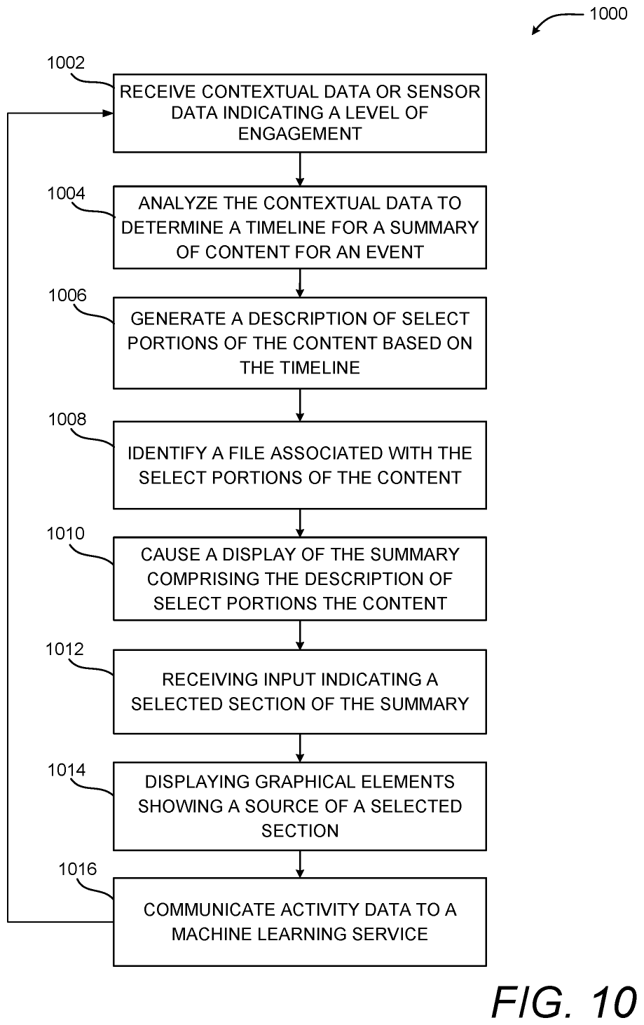

FIG. 10 is a flow diagram illustrating aspects of a routine 1000 for computationally efficient generation and management of a summary. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 1000 is described as running on a system 100, it can be appreciated that the routine 1000 and other operations described herein can be executed on an individual computing device, e.g., computing device 103, or several devices.

Additionally, the operations illustrated in FIG. 10 and the other FIGURES can be implemented in association with the example presentation UIs described above. For instance, the various device(s) and/or module(s) described herein can generate, transmit, receive, and/or display data associated with content of a communication session (e.g., live content, broadcasted event, recorded content, etc.) and/or a presentation UI that includes renderings of one or more participants of remote computing devices, avatars, channels, chat sessions, video streams, images, virtual objects, and/or applications associated with a communication session.

The routine 1000 begins at operation 1002, where a system 100 receives contextual data or sensor data indicating a level of engagement. In some configurations, the contextual data can include communication data from a communication system. Examples of a communication system include systems that provide services such as TEAMS, SLACK, WEBEX, GOTOMEETING, GOOGLE HANGOUTS, etc. A communication system can also include a mobile network that can monitor activity levels of each user in addition to monitoring a location of a user. Sensor data can include any type of signal or data from a sensor such as a camera, a depth map sensor, an infrared motion sensor, a pressure sensor, or any other type of sensor that can detect the movement or activity of a user.

Next, at operation 1004, the system 100 can analyze the contextual data to determine a timeline for a summary of content for an event or a series of events. If a user indicates they are not engaged, e.g., he or she is showing interest in another unrelated event, the system can determine a start time and an end time of a timeline based on such expressions. A facial expression can also be used to determine if a user has a threshold level of engagement. The sensor data can include any signal from a sensor that defines a movement, a facial expression, or any other activity of the user. Some users can show a predetermined facial expression when they are uninterested, and such expressions can be detected and used to determine a start and an end of a timeline.

Other sensor data indicating an eye gaze gesture, or an eye gaze target, can be utilized to determine parameters, e.g. a start time and an end time, of a timeline. The contextual data can include any information defining user activity, such as communication data, scheduling data, location data, etc. As described herein, a combination of contextual data and/or sensor data can be utilized to determine a level of engagement and parameters of a timeline.

In one illustrative example, one or more cameras directed to a particular user can determine the user's eye gaze direction. The system can determine if the user is looking at a particular target such as a podium, stage, a projection of a presentation, a display of specific content, etc. A system may determine that the user's gestures indicate a threshold level of engagement. In one illustrative example, the system may determine that the user may have a threshold level of engagement when the user is looking at a predetermined target. When the user looks at other objects other than the predetermined target, the system may determine that the user does not have a threshold level of engagement. The system may also determine that the user does not have a threshold level of engagement, i.e., that the user's engagement level has dropped below a particular threshold, if the user is looking at other designated targets, such as a personal laptop screen, a cell phone, a tablet, etc. The system can also determine that the user does not have a threshold level of engagement if they close their eyes for a predetermined period of time. The system can determine a timeline based on the timing of the user's level of engagement and generate a summary of select content based on the timeline, e.g., the time frame in which the user was unavailable.

In another illustrative example, one or more cameras and/or other types of sensors, such as location sensors, can be used to determine a person's location. The system can determine if a user leaves a meeting, walks away from a computer screen displaying the contents of a meeting, or makes any other gesture indicating a level of engagement below a particular threshold. With reference to FIG. 1, in a scenario where individuals are participating in a meeting within the conference room, the system can determine the location of each participant in the meeting. When a person leaves the room, the system can determine that person's identity by the identification of the user's physical characteristics, by the use of a facial recognition process, or other processes for determining physical characteristics. The system can thus determine that the person's level of engagement drops below a threshold when the person leaves the room. The system can then determine that the person's level of engagement returns to a threshold level when the person returns to the room.

These examples are provided for illustrative purposes and are not to be construed as limiting. It can be appreciated that other types of activities can be utilized to determine a person's level of engagement. For instance, if the person is engaging in a side conversation during a presentation, the system may determine that the participants of the side conversation have dropped below a threshold level of engagement with the presentation.

A timeline used for selecting content for a summary can be determined by a number of different user activities associated with different types of systems. For instance, during a meeting, if the user begins to use a personal mobile phone to make a private call, the system can determine that the user does not have a threshold level of engagement with respect to an event, such as a meeting. The system can analyze communication data associated with the mobile device or other devices to determine when a user is engaging in a particular conversation outside of a particular context. Thus, the system can generate a summary of content that the user may have missed while the user did not have a threshold level of engagement with respect to an event.

In some configurations, the level of engagement of a user can be measured with respect to a predetermined topic. In such configurations, a system may monitor conversations from individuals participating in a meeting. The system can analyze a user's conversation and determine when the user is discussing a topic outside of the primary topics of a meeting. The system can generate a summary based on a timeline that indicates when the user was discussing the topic outside of the primary topics of the meeting. Thus, when the user re-engages back into a primary discussion of a meeting, a summary may be displayed to assist the user in understanding the context of the presentation or conversation that was missed. This embodiment is helpful when individuals have private conversations or may miss a portion of a lecture when they are distracted by side conversations.

Next, at operation 1006, the system 100 can generate a description of select portions of the content based on the timeline. For instance, as shown in FIG. 2, the system can select portions 50 of content 12 that fall within the parameters of the timeline. The select portions 50 include excerpts from a transcript of a presentation, excerpts of the speech that are translated from an audio file, screenshots of a portion of a video presentation that occurred within the parameters of the timeline, etc. The description of a select portion can include direct quotes from the content or a system may paraphrase or generate a number of sentences that summarize certain types of content. The system may also select portions 50 of the content 12 based on a priority of the content. For instance, the system may identify that a portion of the content includes a task for a particular user. When a task is identified, the system may generate a description of the task and associate the task with a predetermined priority status.

Each portion 50 of the content can include any segment of any shared content. Thus, if a presentation transcript continues for ten minutes, and the start of a timeline is at the five minute marker and the end of the timeline is the nine minute marker, the system can include any segment of the transcript that was delivered after the five minute marker, up to the nine minute marker. The content, such as the transcript, can be truncated at a start or end of a segment. A segment may be defined by any character or data structure that indicates a section delineation, e.g., a period denoting the end of a sentence, a paragraph break, a section break, a page break, etc. Similarly, for spreadsheets and other documents, a segment may include any type of section of data such as a cell or group of cells. Other data formats can include a comma delimited text document, an image having segments delimited by graphical features, etc.

Next, at operation 1008, the system 100 may identify files associated with the select portions of the content. For instance, if a transcript indicates a speaker referred to a file, the system 100 may identify the location of the file based on a file name or other identifier referenced in an event. The system may also analyze the file to obtain information to include in a summary. If the contents of the file have a threshold level of relevancy to the event, e.g., the file was shared or mentioned by a participant or speaker of the event, the system may summarize the contents of the file by the use of computer-generated sentences or by extracting sentences from the file. If the file is a video file, images can be rendered to enable the system 100 to interpret text from the video, and the text may be displayed within a summary. If the file includes an audio component, one or more techniques for transcribing any speech within the audio component can be utilized in a summary. Also shown in FIG. 9, the system may also retrieve a file that is identified in any shared content 12.

Next, at operation 1010, the system can cause the display of a summary having a description of select portions the content and/or the contents of the file. In some configurations, the system may utilize direct quotes from the selected portions 50 and any associated files. Alternatively, a combination of computer-generated sentences and direct quotes from the selected portions of the file may be utilized. In addition, the system can restrict the display of some sections based on permissions for the shared content 12. For instance, a system can determine permissions for a file related to the shared content 12, wherein the permissions can restrict access to a person or a group of people. The system can then redact at least a section of the summary describing the file for the group of users based on the permissions. The system can also provide controlled access to a link for access to the file based on the permissions. The controlled access can require a restricted user to view portions of the file or require a person or group of people to request access from an owner of the file.

Next, at operation 1012, the system receives input indicating a selected section of the summary. At operation 1012, in some embodiments, the selection can involve a first level of interaction, such as a hover or a single tap on a touch device. The first level of interaction can be used to display graphical elements such as user identities or a display of a source for selected content of a summary. A second level of interaction, such as a double tap on a touch device or an actual input from a pointing device, such as a mouse, can be used for other type of actions, e.g., causing a user interface of a document to scroll to a related section, etc. These examples are provided for illustrative purposes and are not to be construed as limiting. It can be appreciated that any level of interaction can be used to invoke different operations disclosed herein.

Next, at operation 1014, the system 100 can display graphic elements showing a source of a selected section of a summary. As described herein, a user input can select a section of a summary and in response to that input, the system can display the names of individuals that contributed to that section of the summary. Operation 1014 can also involve different types of actions such as, but not limited to, causing a user interface to display scheduling data having highlights of events that indicate a source of a selected portion 50 that is included in a summary 11.

Next, at operation 1016, the system can communicate any user activity data, such as a selection of a summary or interaction with the summary, to a machine learning service. Data defining any type of user activity can be communicated to the machine learning service for the purpose of improving the contextual data utilized to determine a user's levels of engagement. Data defining any type of user activity can also be communicated to a machine learning service for the purpose of improving the contextual data utilized to generate and arrange the display of the computer-generated summaries. Thus, as shown in FIG. 10, when the routine 1000 has completed operation 1016 and returns to operation 1002, the results of future iterations of the routine 1000 can produce more refined summaries that are contextually relevant to a user. In addition, future iterations of the routine 1000 can produce more refined determinations regarding a user's level of engagement. For instance, the system can raise or lower one or more thresholds when a system receives input data indicating a user selection of a summary or a selection of a section of a summary. In one example, the system can receive a user input indicating a selection of a section of the summary. The system can then generate a graphical element in response to the selection, wherein the graphical element indicates an event or the portion of the content associated with the section of the summary. This interaction with a summary can cause a computer to communicate user activity defining the selection of the section of the summary to a remote computing device for the purpose of generating a priority of a topic associated with the section of the summary. The priority can cause the system to adjust the engagement threshold to improve the accuracy of the start time or the end time. Any threshold can be adjusted based on a user input applied to a summary.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

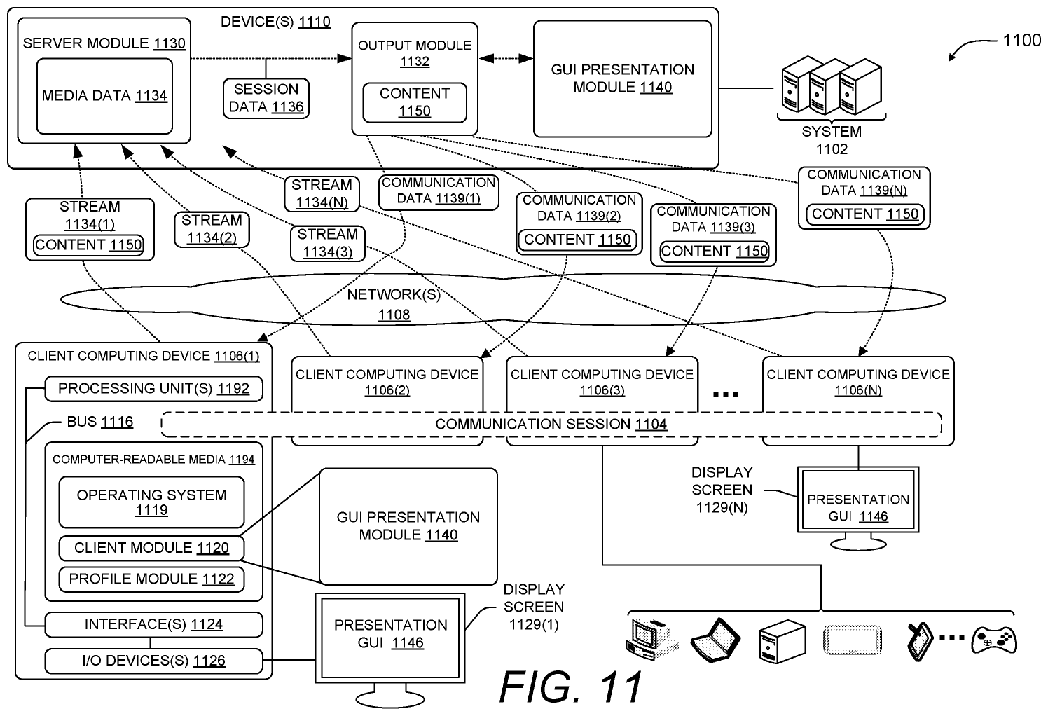

FIG. 11 is a diagram illustrating an example environment 1100 in which a system 1102 can implement the techniques disclosed herein. In some implementations, a system 1102 may function to collect, analyze, and share content that is displayed to users of a communication session 1104. As illustrated, the communication session 1104 may be implemented between a number of client computing devices 1106(1) through 1106(N) (where N is a number having a value of two or greater) that are associated with the system 1102 or are part of the system 1102. The client computing devices 1106(1) through 1106(N) enable users, also referred to as individuals, to participate in the communication session 1104. The client computing devices 1106 can corelate to the user device 103 and the other computing devices 104 shown in FIG. 1. Although some examples show one of the computers 1106 processing aspects of the present techniques, it can be appreciated that the techniques disclosed herein can be applied to other computing devices and are not to be construed as limiting.

In this example, the communication session 1104 is hosted, over one or more network(s) 1108, by the system 1102. That is, the system 1102 can provide a service that enables users of the client computing devices 1106(1) through 1106(N) to participate in the communication session 1104 (e.g., via a live viewing and/or a recorded viewing). Consequently, a “participant” to the communication session 1104 can comprise a user and/or a client computing device (e.g., multiple users may be in a room participating in a communication session via the use of a single client computing device), each of which can communicate with other participants. As an alternative, the communication session 1104 can be hosted by one of the client computing devices 1106(1) through 1106(N) utilizing peer-to-peer technologies. The system 1102 can also host chat conversations and other team collaboration functionality (e.g., as part of an application suite).

In some implementations, such chat conversations and other team collaboration functionality are considered external communication sessions distinct from the communication session 1104. A computerized agent to collect participant data in the communication session 1104 may be able to link to such external communication sessions. Therefore, the computerized agent may receive information, such as date, time, session particulars, and the like, that enables connectivity to such external communication sessions. In one example, a chat conversation can be conducted in accordance with the communication session 1104. Additionally, the system 1102 may host the communication session 1104, which includes at least a plurality of participants co-located at a meeting location, such as a meeting room or auditorium, or located in disparate locations.

In the examples described herein, client computing devices 1106(1) through 1106(N) participating in the communication session 1104 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds may comprise such audio and visual data, one or more still images, and/or one or more avatars. The one or more still images may also comprise one or more avatars.

Another example of an individual stream of live or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live or recorded content within the communication data enable a remote meeting to be facilitated between a group of people and the sharing of content within the group of people. In some implementations, the various streams of live or recorded content within the communication data may originate from a plurality of co-located video cameras, positioned in a space, such as a room, to record or stream live a presentation that includes one or more individuals presenting and one or more individuals consuming presented content.

A participant or attendee can view content of the communication session 1104 live as activity occurs, or alternatively, via a recording at a later time after the activity occurs. In examples described herein, client computing devices 1106(1) through 1106(N) participating in the communication session 1104 are configured to receive and render for display, on a user interface of a display screen, communication data. The communication data can comprise a collection of various instances, or streams, of live and/or recorded content. For example, an individual stream of content can comprise media data associated with a video feed (e.g., audio and visual data that capture the appearance and speech of a user participating in the communication session). Another example of an individual stream of content can comprise media data that includes an avatar of a user participating in the conference session along with audio data that captures the speech of the user. Yet another example of an individual stream of content can comprise media data that includes a content item displayed on a display screen and/or audio data that captures the speech of a user. Accordingly, the various streams of content within the communication data enable a meeting or a broadcast presentation to be facilitated amongst a group of people dispersed across remote locations. Each stream can also include text, audio and video data, such as the data communicated within a Channel, chat board, or a private messaging service.

A participant or attendee to a communication session is a person that is in range of a camera, or other image and/or audio capture device such that actions and/or sounds of the person which are produced while the person is viewing and/or listening to the content being shared via the communication session can be captured (e.g., recorded). For instance, a participant may be sitting in a crowd viewing the shared content live at a broadcast location where a stage presentation occurs. Or a participant may be sitting in an office conference room viewing the shared content of a communication session with other colleagues via a display screen. Even further, a participant may be sitting or standing in front of a personal device (e.g., tablet, smartphone, computer, etc.) viewing the shared content of a communication session alone in their office or at home.

The system 1102 includes device(s) 1110. The device(s) 1110 and/or other components of the system 1102 can include distributed computing resources that communicate with one another and/or with the client computing devices 1106(1) through 1106(N) via the one or more network(s) 1108. In some examples, the system 1102 may be an independent system that is tasked with managing aspects of one or more communication sessions such as communication session 1104. As an example, the system 1102 may be managed by entities such as SLACK, WEBEX, GOTOMEETING, GOOGLE HANGOUTS, etc.

Network(s) 1108 may include, for example, public networks such as the Internet, private networks such as an institutional and/or personal intranet, or some combination of private and public networks. Network(s) 1108 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 1108 may utilize communications protocols, including packet-based and/or datagram-based protocols such as Internet protocol (“IP”), transmission control protocol (“TCP”), user datagram protocol (“UDP”), or other types of protocols. Moreover, network(s) 1108 may also include a number of devices that facilitate network communications and/or form a hardware basis for the networks, such as switches, routers, gateways, access points, firewalls, base stations, repeaters, backbone devices, and the like.

In some examples, network(s) 1108 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 1110 may include one or more computing devices that operate in a cluster or other grouped configuration to share resources, balance load, increase performance, provide fail-over support or redundancy, or for other purposes. For instance, device(s) 1110 may belong to a variety of classes of devices such as traditional server-type devices, desktop computer-type devices, and/or mobile-type devices. Thus, although illustrated as a single type of device or a server-type device, device(s) 1110 may include a diverse variety of device types and are not limited to a particular type of device. Device(s) 1110 may represent, but are not limited to, server computers, desktop computers, web-server computers, personal computers, mobile computers, laptop computers, tablet computers, or any other sort of computing device.

A client computing device (e.g., one of client computing device(s) 1106(1) through 1106(N)) may belong to a variety of classes of devices, which may be the same as, or different from, device(s) 1110, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 1106(1) through 1106(N) of the various classes and device types can represent any type of computing device having one or more data processing unit(s) 1192 operably connected to computer-readable media 1194 such as via a bus 1116, which in some instances can include one or more of a system bus, a data bus, an address bus, a PCI bus, a Mini-PCI bus, and any variety of local, peripheral, and/or independent buses.

Executable instructions stored on computer-readable media 1194 may include, for example, an operating system 1119, a client module 1120, a profile module 1122, and other modules, programs, or applications that are loadable and executable by data processing units(s) 1192.

Client computing device(s) 1106(1) through 1106(N) may also include one or more interface(s) 1124 to enable communications between client computing device(s) 1106(1) through 1106(N) and other networked devices, such as device(s) 1110, over network(s) 1108. Such network interface(s) 1124 may include one or more network interface controllers (NICs) or other types of transceiver devices (not shown in FIG. 11) to send and receive communications and/or data over a network. Moreover, client computing device(s) 1106(1) through 1106(N) can include input/output (“I/O”) interfaces (devices) 1126 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 11 illustrates that client computing device 1106(1) is in some way connected to a display device (e.g., a display screen 1129(1)), which can display a UI according to the techniques described herein.

In the example environment 1100 of FIG. 11, client computing devices 1106(1) through 1106(N) may use their respective client modules 1120 to connect with one another and/or other external device(s) in order to participate in the communication session 1104, or in order to contribute activity to a collaboration environment. For instance, a first user may utilize a client computing device 1106(1) to communicate with a second user of another client computing device 1106(2). When executing client modules 1120, the users may share data, which may cause the client computing device 1106(1) to connect to the system 1102 and/or the other client computing devices 1106(2) through 1106(N) over the network(s) 1108.

The client computing device(s) 1106(1) through 1106(N) (each of which are also referred to herein as a “data processing system”) may use their respective profile modules 1122 to generate participant profiles (not shown in FIG. 11) and provide the participant profiles to other client computing devices and/or to the device(s) 1110 of the system 1102. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 11, the device(s) 1110 of the system 1102 include a server module 1130 and an output module 1132. In this example, the server module 1130 is configured to receive, from individual client computing devices such as client computing devices 1106(1) through 1106(N), media streams 1134(1) through 1134(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 1130 is configured to receive a collection of various media streams 1134(1) through 1134(N) during a live viewing of the communication session 1104 (the collection being referred to herein as “media data 1134”). In some scenarios, not all of the client computing devices that participate in the communication session 1104 provide a media stream. For example, a client computing device may only be a consuming, or a “listening”, device such that it only receives content associated with the communication session 1104 but does not provide any content to the communication session 1104.

In various examples, the server module 1130 can select aspects of the media streams 1134 that are to be shared with individual ones of the participating client computing devices 1106(1) through 1106(N). Consequently, the server module 1130 may be configured to generate session data 1136 based on the streams 1134 and/or pass the session data 1136 to the output module 1132. Then, the output module 1132 may communicate communication data 1139 to the client computing devices (e.g., client computing devices 1106(1) through 1106(3) participating in a live viewing of the communication session). The communication data 1139 may include video, audio, and/or other content data, provided by the output module 1132 based on content 1150 associated with the output module 1132 and based on received session data 1136.

As shown, the output module 1132 transmits communication data 1139(1) to client computing device 1106(1), and transmits communication data 1139(2) to client computing device 1106(2), and transmits communication data 1139(3) to client computing device 1106(3), etc. The communication data 1139 transmitted to the client computing devices can be the same or can be different (e.g., positioning of streams of content within a user interface may vary from one device to the next).

In various implementations, the device(s) 1110 and/or the client module 1120 can include GUI presentation module 1140. The GUI presentation module 1140 may be configured to analyze communication data 1139 that is for delivery to one or more of the client computing devices 1106. Specifically, the GUI presentation module 1140, at the device(s) 1110 and/or the client computing device 1106, may analyze communication data 1139 to determine an appropriate manner for displaying video, image, and/or content on the display screen 1129(1) of an associated client computing device 1106. In some implementations, the GUI presentation module 1140 may provide video, image, and/or content to a presentation GUI 1146 rendered on the display screen 1129(1) of the associated client computing device 1106. The presentation GUI 1146 may be caused to be rendered on the display screen 1129(1) by the GUI presentation module 1140. The presentation GUI 1146 may include the video, image, and/or content analyzed by the GUI presentation module 1140.

In some implementations, the presentation GUI 1146 may include a plurality of sections or grids that may render or comprise video, image, and/or content for display on the display screen 1129. For example, a first section of the presentation GUI 1146 may include a video feed of a presenter or individual, and a second section of the presentation GUI 1146 may include a video feed of an individual consuming meeting information provided by the presenter or individual. The GUI presentation module 1140 may populate the first and second sections of the presentation GUI 1146 in a manner that properly imitates an environment experience that the presenter and the individual may be sharing.

In some implementations, the GUI presentation module 1140 may enlarge or provide a zoomed view of the individual represented by the video feed in order to highlight a reaction, such as a facial feature, the individual had while viewing the presenter. In some implementations, the presentation GUI 1146 may include a video feed of a plurality of participants associated with a meeting, such as a general communication session. In other implementations, the presentation GUI 1146 may be associated with a channel, such as a chat channel, enterprise teams channel, or the like. Therefore, the presentation GUI 1146 may be associated with an external communication session that is different than the general communication session.

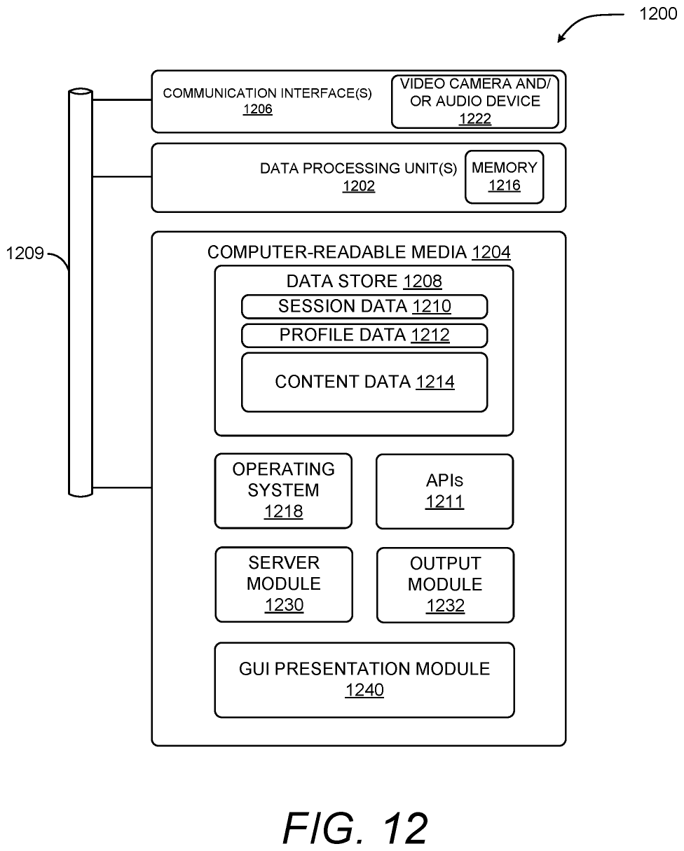

FIG. 12 illustrates a diagram that shows example components of an example device 1200 (also referred to herein as a “computing device”) configured to generate data for some of the user interfaces disclosed herein. The device 1200 may generate data that may include one or more sections that may render or comprise video, images, virtual objects, and/or content for display on the display screen 1129. The device 1200 may represent one of the device(s) described herein. Additionally, or alternatively, the device 1200 may represent one of the client computing devices 1106.

As illustrated, the device 1200 includes one or more data processing unit(s) 1202, computer-readable media 1204, and communication interface(s) 1206. The components of the device 1200 are operatively connected, for example, via a bus 1209, which may include one or more of a system bus, a data bus, an address bus, a PCI bus, a Mini-PCI bus, and any variety of local, peripheral, and/or independent buses.

As utilized herein, data processing unit(s), such as the data processing unit(s) 1202 and/or data processing unit(s)1192, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 1204 and computer-readable media 1194, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 1206 may represent, for example, network interface controllers (“NICs”) (not shown in FIG. 12) or other types of transceiver devices to send and receive communications over a network. Furthermore, the communication interface(s) 1206 may include one or more video cameras and/or audio devices 1222 to enable generation of video feeds and/or still images, and so forth.

In the illustrated example, computer-readable media 1204 includes a data store 1208. In some examples, the data store 1208 includes data storage such as a database, data warehouse, or other type of structured or unstructured data storage. In some examples, the data store 1208 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 1208 may store data for the operations of processes, applications, components, and/or modules stored in computer-readable media 1204 and/or executed by data processing unit(s) 1202 and/or accelerator(s). For instance, in some examples, the data store 1208 may store session data 1210 (e.g., session data 1136), profile data 1212 (e.g., associated with a participant profile), and/or other data. The session data 1210 can include a total number of participants (e.g., users and/or client computing devices) in a communication session, activity that occurs in the communication session, a list of invitees to the communication session, and/or other data related to when and how the communication session is conducted or hosted. The data store 1208 may also include content data 1214, such as the content that includes video, audio, or other content for rendering and display on one or more of the display screens 1129.

Alternately, some or all of the above-referenced data can be stored on separate memories 1216 on board one or more data processing unit(s) 1202 such as a memory on board a CPU-type processor, a GPU-type processor, an FPGA-type accelerator, a DSP-type accelerator, and/or another accelerator. In this example, the computer-readable media 1204 also includes an operating system 1218 and application programming interface(s) 1211 (APIs) configured to expose the functionality and the data of the device 1200 to other devices. Additionally, the computer-readable media 1204 includes one or more modules such as the server module 1230, the output module 1232, and the GUI presentation module 1240, although the number of illustrated modules is just an example, and the number may vary higher or lower. That is, functionality described herein in association with the illustrated modules may be performed by a fewer number of modules or a larger number of modules on one device or spread across multiple devices.

It is to be appreciated that conditional language used herein such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

It should also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method to be performed by a data processing system, the method comprising:
receiving, at the data processing system, contextual data indicating a level of engagement of a user;
analyzing the contextual data to determine a timeline for a summary of content, wherein a start of the timeline is based on a time when the level of engagement falls below an engagement threshold, and an end of the timeline is based on a time when the level of engagement meets the engagement threshold;
analyzing content data to generate a description of select portions of the content that are within the start and end of the timeline;
identifying a file associated with the select portions of the content; and
causing a display of the summary comprising the description of select portions of the content and a graphical element providing access to the file.

2. The method of claim 1, wherein the contextual data comprises image data indicating a gaze direction of the user, wherein the level of engagement meets the engagement threshold in response to determining that the gaze direction is directed towards a predetermined target, and wherein the level of engagement does not meet the engagement threshold in response to determining that the gaze direction is directed away from the predetermined target for a threshold time (T).

3. The method of claim 2, wherein the predetermined target includes a display of the content.

4. The method of claim 1, wherein the contextual data defines a location indicator and scheduling data, wherein the level of engagement meets the engagement threshold in response to determining that the location indicator confirms that a location of the user is within a threshold distance from a location of an event defined in the scheduling data, and wherein the level of engagement does not meet the engagement threshold in response to determining that the location indicator confirms that the location of the user is not within the threshold distance from a location of an event defined in the scheduling data.

5. The method of claim 1, wherein the contextual data defines a location indicator, wherein the level of engagement meets the engagement threshold in response to determining that the location indicator confirms that a location of the user is within a threshold distance from a predetermined location, and wherein the level of engagement does not meet the engagement threshold in response to determining that the location indicator confirms that the location of the user is not within the threshold distance from the predetermined location.

6. The method of claim 1, wherein the contextual data defines a location indicator and scheduling data, wherein the level of engagement meets the engagement threshold in response to determining that the location indicator confirms that a location of the user is within a threshold distance from a location of an event defined in the scheduling data, and wherein the level of engagement does not meet the engagement threshold in response to determining that the location indicator confirms that the location of the user is not within the threshold distance from a location of an event defined in the scheduling data.

7. The method of claim 1, further comprising:
receiving a user input indicating a selection of a section of the summary; and
generating a graphical element in response to the selection, wherein the graphical element indicates an event or the portion of the content associated with the section of the summary.

8. The method of claim 1, further comprising generating a graphical element in association with a first section of the summary, the graphical element indicating a source of a content description within the first section.

9. The method of claim 1, further comprising:
determining permissions for the file, wherein the permissions restrict access to a group of users; and
redacting at least a section of the summary describing the file for the group of users based on the permissions.

10. A system comprising:
one or more data processing units; and
a computer-readable medium having encoded thereon computer-executable instructions to cause the one or more data processing units to:
receive, at the system, contextual data indicating a level of engagement of a user;
analyze the contextual data to determine a timeline for a summary of content, wherein a start of the timeline is based on a time when the level of engagement falls below an engagement threshold, and an end of the timeline is based on a time when the level of engagement meets the engagement threshold;
analyze content data to generate a description of select portions of the content that are within the start and end of the timeline; and
cause a display of the summary comprising the description of select portions of the content.

11. The system of claim 10, wherein the instructions further cause the one or more data processing units to:
receive a user input indicating a selection of a section of the summary;
generate a graphical element in response to the selection, wherein the graphical element indicates an event or the portion of the content associated with the section of the summary; and
communicate user activity defining the selection of the section of the summary for causing a remote computing device to generate a priority of a topic associated with the section of the summary, the priority causing the system to adjust the engagement threshold to improve the accuracy of the start time or the end time.

12. The system of claim 10, wherein the contextual data comprises image data indicating a gaze direction of the user, wherein the level of engagement meets the engagement threshold in response to determining that the gaze direction is directed towards a display of the content, and wherein the level of engagement does not meet the engagement threshold in response to determining that the gaze direction is directed away from the display of the content for a threshold time (T).

13. The system of claim 10, wherein the contextual data defines a location indicator and scheduling data, wherein the level of engagement meets the engagement threshold in response to determining that the location indicator confirms that a location of the user is within a threshold distance from a location of an event defined in the scheduling data, and wherein the level of engagement does not meet the engagement threshold in response to determining that the location indicator confirms that the location of the user is not within the threshold distance from a location of an event defined in the scheduling data.

14. The system of claim 10, wherein the contextual data defines a location indicator, wherein the level of engagement meets the engagement threshold in response to determining that the location indicator confirms that a location of the user is within a threshold distance from a predetermined location, and wherein the level of engagement does not meet the engagement threshold in response to determining that the location indicator confirms that the location of the user is not within the threshold distance from the predetermined location.

15. The system of claim 10, wherein the contextual data defines a location indicator and scheduling data, wherein the level of engagement meets the engagement threshold in response to determining that the location indicator confirms that a location of the user is within a threshold distance from a location of an event defined in the scheduling data, and wherein the level of engagement does not meet the engagement threshold in response to determining that the location indicator confirms that the location of the user is not within the threshold distance from a location of an event defined in the scheduling data.

16. A system, comprising:
means for receiving, at the system, contextual data indicating a level of engagement of a user;
means for analyzing the contextual data to determine a timeline for a summary of content, wherein a start of the timeline is based on a time when the level of engagement falls below an engagement threshold, and an end of the timeline is based on a time when the level of engagement meets the engagement threshold;
means for analyzing content data to generate a description of select portions of the content that are within the start and end of the timeline;
means for identifying a file associated with the select portions of the content; and
means for causing a display of the summary comprising the description of select portions of the content and a graphical element providing access to the file, wherein the summary is updated with the select portions before an event, during the event, or after the event.

17. The system of claim 16, wherein the contextual data defines a location indicator and scheduling data, wherein the level of engagement meets the engagement threshold in response to determining that the location indicator confirms that a location of the user is within a threshold distance from a location of an event defined in the scheduling data, and wherein the level of engagement does not meet the engagement threshold in response to determining that the location indicator confirms that the location of the user is not within the threshold distance from a location of an event defined in the scheduling data.

18. The system of claim 16, wherein the contextual data defines a location indicator, wherein the level of engagement meets the engagement threshold in response to determining that the location indicator confirms that a location of the user is within a threshold distance from a predetermined location, and wherein the level of engagement does not meet the engagement threshold in response to determining that the location indicator confirms that the location of the user is not within the threshold distance from the predetermined location.

19. The system of claim 16, wherein the contextual data defines a location indicator and scheduling data, wherein the level of engagement meets the engagement threshold in response to determining that the location indicator confirms that a location of the user is within a threshold distance from a location of an event defined in the scheduling data, and wherein the level of engagement does not meet the engagement threshold in response to determining that the location indicator confirms that the location of the user is not within the threshold distance from a location of an event defined in the scheduling data.

20. The system of claim 16, wherein the system further comprises means for generating a graphical element in association with a first section of the summary, the graphical element indicating a source of a content description within the first section.
